(19) United States
(12) Patent Application Publication
(10) Pub. No.: US 2015/0160819 A1
(43) Pub. Date: Jun. 11, 2015

(54) Crane Gesture

(71) Applicant: MICROSOFT CORPORATION, Redmond, WA (US)

(72) Inventors: Dan Hwang, New Castle, WA (US); Scott Greenlay, Redmond, WA (US); Christopher Fellows, Redmond, WA (US); Thamer Abanami, Seattle, WA (US); Jose Rodriguez, Seattle, WA (US); Joe Tobens, Settle, WA (US)

(21) Appl. No.: 14/098,952

(22) Filed: Dec. 6, 2013

(51) Int. Cl. G06F 3/0486; G06F 3/041; G06F 3/0488; G06F 3/01

(52) U.S. Cl. CPC G06F 3/0486; G06F 3/017; G06F 3/0416; G06F 3/04883; G06F 2203/04101; G06F 2203/04104

(57) ABSTRACT

Example apparatus and methods concern detecting and responding to a crane gesture performed for a touch or hover-sensitive device. An example apparatus may include a hover-sensitive input/output interface configured to display an object that can be manipulated using a crane gesture. The apparatus may include a proximity detector configured to detect an object in a hover-space associated with the hover-sensitive input/output interface. The apparatus may include fogies configured to change a state of the object from untouched to target to pinched to lifted to released in response to detecting the appearance and movement of bracket points. The appearance of the object may change in response to detecting the state changes.

### BACKGROUND

Devices like smart phones and tablets may be configured with screens that are both touch-sensitive and hover-sensitive. Conventionally, touch-sensitive screens have supported gestures where one or two fingers were placed on the touch-sensitive screen then moved in an identifiable pattern. For example, users may interact with an input/output interface on the touch-sensitive screen using gestures like a swipe, a pinch, a spread, a tap or double tap, or other gestures. Hover-sensitive screens may rely on proximity detectors to detect objects that are within a certain distance of the screen. Conventional hover-sensitive screens detected single objects in a hover-space associated with the hover-sensitive device and responded to events like a hover-space entry event or a hover-space exit event. Reacting appropriately to user actions depends, at least in part, on correctly identifying touch points, hover points and actions taken by the objects (e.g., fingers) associated with touch points or hover points.

Conventionally, devices with screens that are both touch-sensitive and hover-sensitive may have responded to touch events or to hover events but not to both. While a rich set of interactions may be possible using a screen in a touch mode or a hover mode, this binary approach may have limited the richness of the experience possible for an interface that is both touch-sensitive and hover-sensitive.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

Example methods and apparatus are directed towards interacting with a device using a crane gesture. A crane gesture may rely on a sequence or combination of gestures to produce a different user interaction with a screen that has hover-sensitivity. A crane gesture may include identifying an object displayed on the screen that may be the subject of a crane gesture. The crane gesture may also include virtually pinching the object with a touch gesture, virtually lifting the object with a touch to hover transition, virtually carrying the object to another location on the screen using a hover gesture, and then releasing the object at the other location with a hover gesture or a touch gesture. By using both the touch capability and the hover capability provided by an interface that is both touch-sensitive and hover-sensitive, example methods and apparatus provide a new gesture that may be intuitive for users and that may increase productivity or facilitate new interactions with applications (e.g., games, email, video editing) running on a device with the interface. In one embodiment, the crane gesture may implemented using just hover gestures.

Some embodiments may include logics that detect elements of the crane gesture and that maintain a state machine and user interface in response to detecting the elements of the crane gesture. Detecting elements of the crane gesture may involve receiving events from the user interface. For example, events like a hover enter event, a hover to touch transition event, a touch pinch event or a swipe pinch event, a touch to hover transition event, a hover retreat event, and a hover spread event may be detected as a user virtually pinches an item on the screen, virtually lifts the item, virtually carries the item to another location, and then virtually releases the item. Some embodiments may also produce gesture events that can be handled or otherwise processed by other devices or processes.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates an example hover-sensitive device.

FIG. 2 illustrates an example state diagram associated with an example crane gesture.

FIG. 3 illustrates an example state diagram associated with an example crane gesture.

FIG. 4 illustrates an example state diagram associated with an example crane gesture.

FIG. 5 illustrates an example interaction with an example hover-sensitive device.

FIG. 6 illustrates actions, objects, and data associated with a crane-start event or state.

FIG. 7 illustrates actions, objects, and data associated with a crane-start event or state.

FIG. 8 illustrates actions, objects, and data associated with a crane-start event or state.

FIG. 9 illustrates actions, objects, and data associated with a crane-grab event or state.

FIG. 10 illustrates actions, objects, and data associated with a crane-grab event or state.

FIG. 11 illustrates actions, objects, and data associated with a crane-lift event or state.

FIG. 12 illustrates actions, objects, and data associated with a crane-carry event or state.

FIG. 13 illustrates actions, objects, and data associated with a crane-carry event or state.

FIG. 14 illustrates actions, objects, and data associated with a crane-release event or state.

FIG. 15 illustrates an example method associated with a crane gesture.

FIG. 16 illustrates an example method associated with a crane gesture.

FIG. 17 illustrates an example apparatus configured to support a crane gesture.

FIG. 18 illustrates an example apparatus configured to support a crane gesture.

FIG. 19 illustrates an example cloud operating environment in which an apparatus configured to interact with a user through a crane gesture may operate.

FIG. 20 is a system diagram depicting an exemplary mobile communication device configured to interact with a user through a crane gesture.

FIG. 21 represents an example first step in an example crane gesture.

FIG. 22 represents an example second step in an example crane gesture.

FIG. 23 represents an example third step in an example crane gesture.

FIG. 24 represents an example fourth step in an example crane gesture.

FIG. 25 represents an example fifth step in an example crane gesture.

FIG. 26 illustrates an example z distance and z direction in an example apparatus configured to perform a crane gesture.

FIG. 27 illustrates an example displacement in an x-y plane and in a z direction from an initial point.

### DETAILED DESCRIPTION

Example apparatus and methods concern a crane gesture interaction with a device. The device may have an interface that is both hover-sensitive and touch-sensitive. The crane gesture allows a user to appear to pick up an item on a display, to carry it to another location, and to release the item using hand and finger actions that simulate picking up, moving, and putting down an actual item. In one embodiment, the crane gesture may include both hover and touch events. In another embodiment, the crane gesture may include just hover events.

Consider a physical block sitting on a desk. A person who wanted to move the block from one place on their desk to another place on the desk may pinch the block between their thumb and index finger, pick up the block, move it to another spot on their desk, and spread their finger and thumb to put the block down. The user may re-orient the block while it is being moved. During the actions, the person's fingers may or may not come in contact with the desk. In one embodiment, unlike the physical block, which can only reside at one location at one time, the crane gesture may allow a virtual item like a block displayed on an interface to be replicated by being placed down in multiple locations. In one embodiment, like the block may be picked up and removed from the desk by moving the block off the edge of the desk, the virtual item may be lifted from the display and discarded by moving the item off the edge of the display or by lifting the item out of the hover space. This discard feature may simplify deleting objects because instead of having to move the item to a specific location (e.g., garbage can icon), the item can simply be removed from the display thereby reducing the number of actions required to discard an item and reducing the accuracy required to discard an item. In one embodiment, when the object is released while being moved in an x/y plane above the display, the object may appear to be thrown. In another embodiment, when the object is released while being rotated in the x/y plane, the object may appear to be spinning.

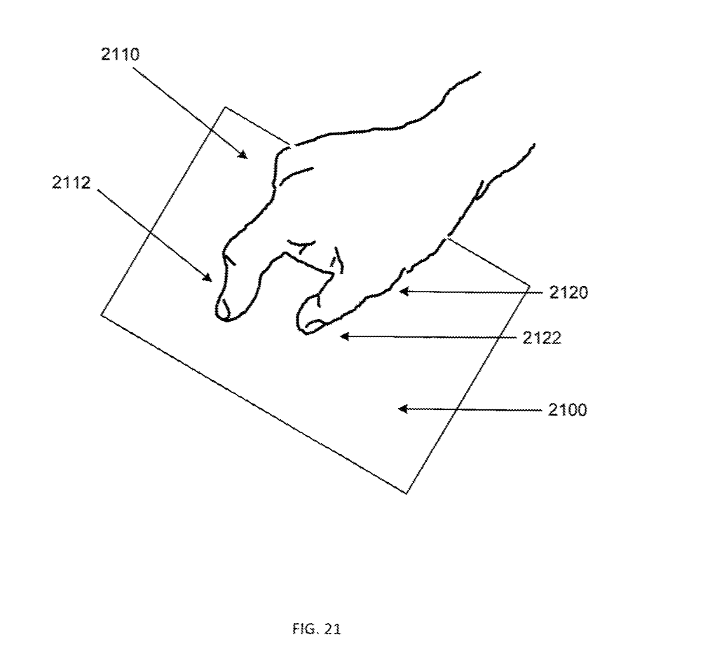

FIG. 21 represents an example first step in an example crane gesture. The crane gesture may be associated with a method that includes accessing a user interface for an apparatus having a hover-sensitive input/output display and then selectively controlling the user interface in response to a crane gesture performed using the hover-sensitive input/output display. Finger 2110 has produced a touch point 2112 on hover and touch sensitive apparatus 2100. Finger 2120 has also produced a touch point 2122 on apparatus 2100. If the touch points 2112 and 2122 bracket an object that can be virtually lifted from the display on apparatus 2100, then a crane gesture may begin.

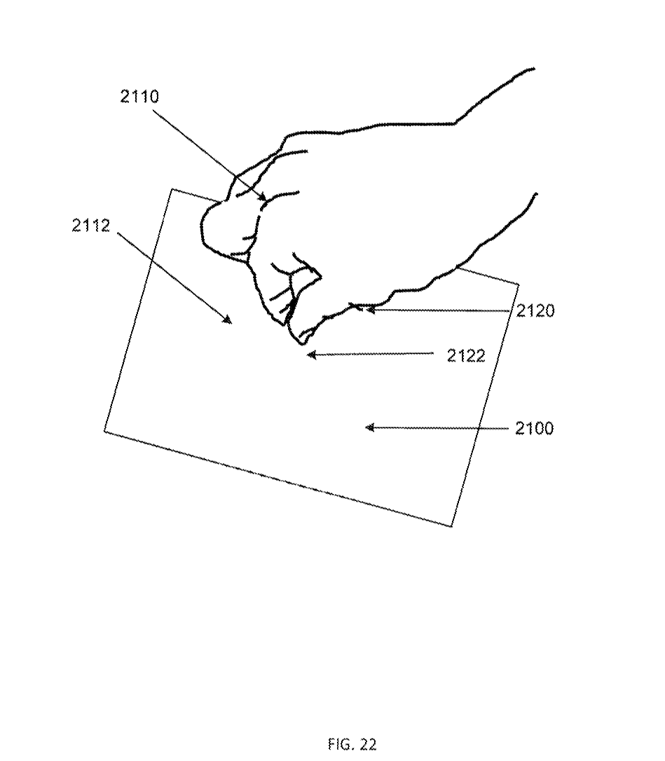

FIG. 22 represents an example second step in an example crane gesture. Finger 2110 and finger 2120 have pinched together causing touch points 2112 and 2122 to move together. If the touch points 2112 and 2122 satisfy pinch constraints, then the crane gesture may progress to have virtually pinched an object on the display on apparatus 2100.

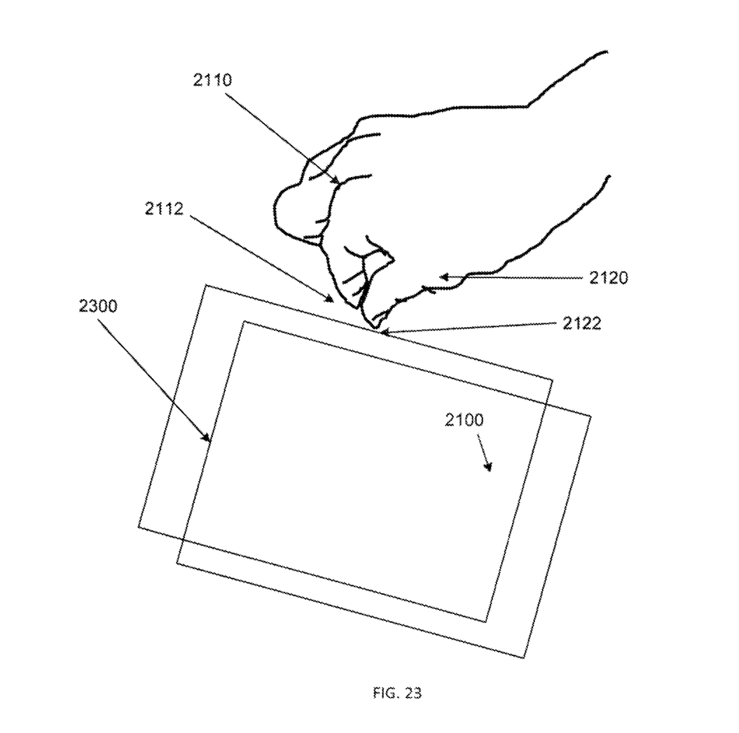

FIG. 23 represents an example third step in an example crane gesture. Finger 2110 and finger 2120 have lifted off the display and are located in an x-y plane 2300 in the hover space above apparatus 2100. The touch points 2112 and 2122 have transitioned to hover points. If finger 2110 and 2120 have lifted a sufficient distance off the display while still pinching the virtual object, then the crane gesture may progress to have virtually lifted the object off the display and into the x-y plane 2300.

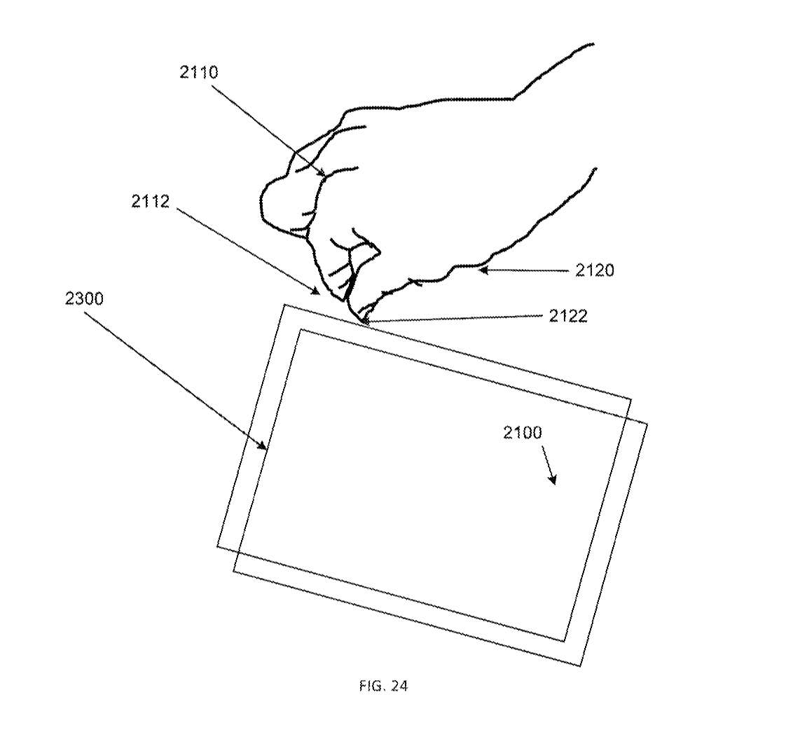

FIG. 24 represents an example fourth step in an example crane gesture. Fingers 2110 and 2120 have moved in the x-y plane 2300 to another location over apparatus 2100. The hover points 2112 and 2122 have also moved. If the hover points 2112 and 2122 have moved a sufficient distance in the x-y plane, then the crane gesture may progress to have virtually moved the object from one virtual location to another virtual location.

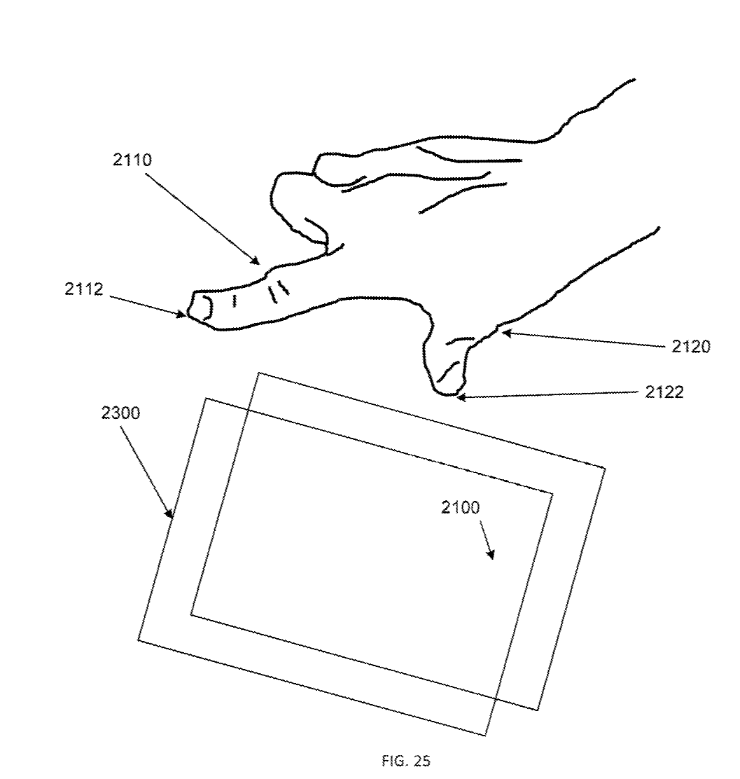

FIG. 25 represents an example fifth step in an example crane gesture. Fingers 2110 and 2120 have moved apart from each other. This virtually releases the object that was pinched, lifted, and carried to the new virtual location. The location at which the object will be placed on the display on apparatus 2100 may depend, at least in part, on the location of hover points 2112 and 2122.

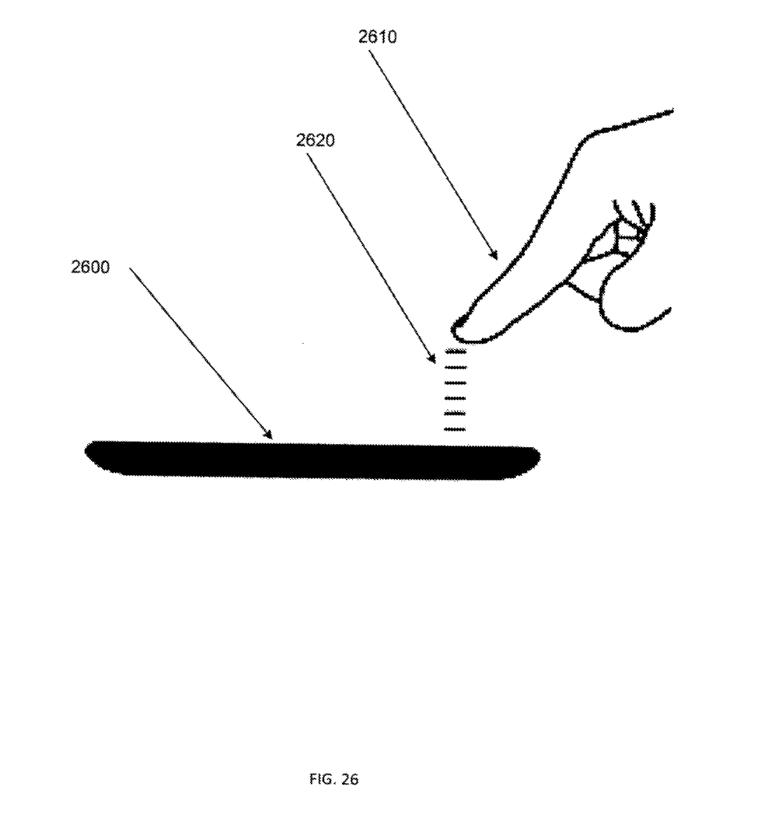

FIG. 26 illustrates an example z distance 2620 and z direction associated with an example apparatus 2600 configured to perform a crane gesture. The z distance may be perpendicular to apparatus 2600 and may be determined by how far the tip of finger 2610 is located from apparatus 2600.

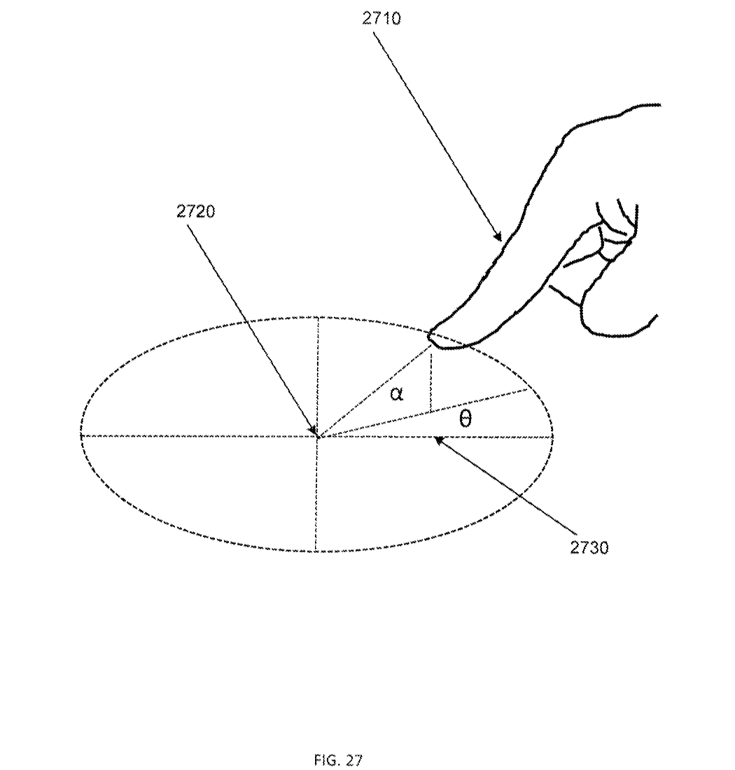

FIG. 27 illustrates an example displacement in an x-y plane from an initial point 2720. Finger 2710 may initially have been located above initial point 2720. Finger 2710 may then have moved to be above subsequent point 2730. In one embodiment, the locations of points 2720 and 2730 may be described by (x,y,z) co-ordinates. In another embodiment, the subsequent point 2730 may be described in relation to initial point 2720. For example, a distance, angle in the x-y plane, and angle in the z direction may be employed.

Hover technology is used to detect an object in a hover-space. “Hover technology” and “hover-sensitive” refer to sensing an object spaced away from (e.g., not touching) yet in close proximity to a display in an electronic device. “Close proximity” may mean, for example, beyond 1 mm but within 1 cm, beyond 0.1 mm but within 10 cm, or other combinations of ranges. Being in close proximity includes being within a range where a proximity detector can detect and characterize an object in the hover-space. The device may be, for example, a phone, a tablet computer, a computer, or other device. Hover technology may depend on a proximity detector(s) associated with the device that is hover-sensitive. Example apparatus may include the proximity detector(s).

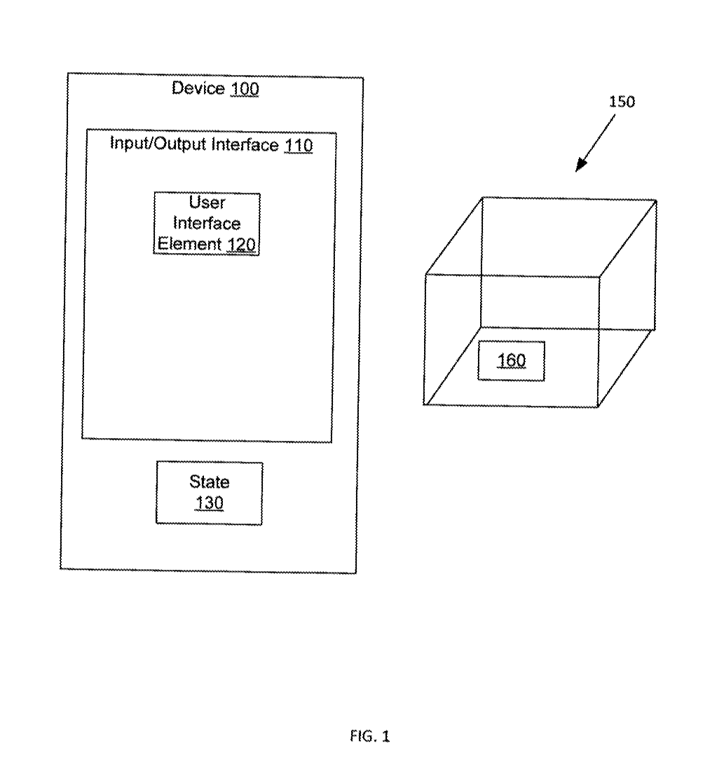

FIG. 1 illustrates an example hover-sensitive device 100. Device 100 includes an input/output (i/o) interface 110. I/O interface 110 is hover-sensitive. I/O interface 110 may display a set of items including, for example, a user interface element 120. User interface elements may be used to display information and to receive user interactions. Hover user interactions may be performed in the hover-space 150 without touching the device 100. Touch interactions may be performed by touching the device 100 by, for example, touching the i/o interface 110. Device 100 or i/o interface 110 may store state 130 about the user interface element 120 or other items that are displayed. The state 130 of the user interface element 120 may depend on touch gestures or hover gestures. The state 130 may include, for example, the location of an object displayed on the i/o interface 110, whether the object has been bracketed, whether the object has been pinched, whether the object has been lifted while pinched, whether the object has been, moved while pinched and lifted, whether an object that has been pinched and lifted has been released, or other information. The state information may be saved in a computer memory.

The device 100 may include a proximity detector that detects when an object (e.g., digit, pencil, stylus with capacitive tip) is close to but not touching the i/o interface 110. The proximity detector may identify the location (x, y, z) of an object (e.g., finger) 160 in the three-dimensional hover-space 150, where x and y are parallel to the proximity detector and z is perpendicular to the proximity detector. The proximity detector may also identify other attributes of the object 160 including, for example, how close the object is to the i/o interface (e.g., z distance), the speed with which the object 160 is moving in the hover-space 150, the orientation (e.g., pitch, roll, yaw) of the object 160 with respect to the hover-space 150, the direction in which the object 160 is moving with respect to the hover-space 150 or device 100 (e.g., approaching, retreating), a gesture (e.g., pinch, spread) made by the object 160, or other attributes of the object 160. While a single object 160 is illustrated, the proximity detector may detect more than one object in the hover-space 150.

In different examples, the proximity detector may use active or passive systems. For example, the proximity detector may use sensing technologies including, but not limited to, capacitive, electric field, inductive, Hall effect, Reed effect, Eddy current, magneto resistive, optical shadow, optical visual light, optical infrared (IR), optical color recognition, ultrasonic, acoustic emission, radar, heat, sonar, conductive, and resistive technologies. Active systems may include, among other systems, infrared or ultrasonic systems. Passive systems may include, among other systems, capacitive or optical shadow systems. In one embodiment, when the proximity detector uses capacitive technology, the detector may include a set of capacitive sensing nodes to detect a capacitance change in the hover-space 150. The capacitance change may be caused, for example, by a digit(s) (e.g., finger, thumb) or other object(s) (e.g., pen, capacitive stylus) that comes within the detection range of the capacitive sensing nodes. In another embodiment, when the proximity detector uses infrared light, the proximity detector may transmit infrared light and detect reflections of that light from an object within the detection range (e.g., in the hover-space 150) of the infrared sensors. Similarly, when the proximity detector uses ultrasonic sound, the proximity detector may transmit a sound into the hover-space 150 and then measure the echoes of the sounds. In another embodiment, when the proximity detector uses a photo-detector, the proximity detector may track changes in light intensity. Increases in intensity may reveal the removal of an object from the hover-space 150 while decreases in intensity may reveal the entry of an object into the hover-space 150.

In general, a proximity detector includes a set of proximity sensors that generate a set of sensing fields in the hover-space 150 associated with the i/o interface 110. The proximity detector generates a signal when an object is detected in the hover-space 150. In one embodiment, a single sensing field may be employed. In other embodiments, two or more sensing fields may be employed. In one embodiment, a single technology may be used to detect or characterize the object 160 in the hover-space 150. In another embodiment, a combination of two or more technologies may be used to detect or characterize the object 160 in the hover-space 150.

In one embodiment, characterizing the object includes receiving a signal from a detection system (e.g., proximity detector) provided by the device. The detection system may be an active detection system (e.g., infrared, ultrasonic), a passive detection system (e.g., capacitive), or a combination of systems. The detection system may be incorporated into the device or provided by the device.

Characterizing the object may also include other actions. For example, characterizing the object may include determining that an object (e.g., digit, stylus) has entered the hover-space or has left the hover-space. Characterizing the object may also include identifying the presence of an object at a pre-determined location in the hover-space. The pre-determined location may be relative to the i/o interface or may be relative to the position of a particular user interface element or to user interface element 120.

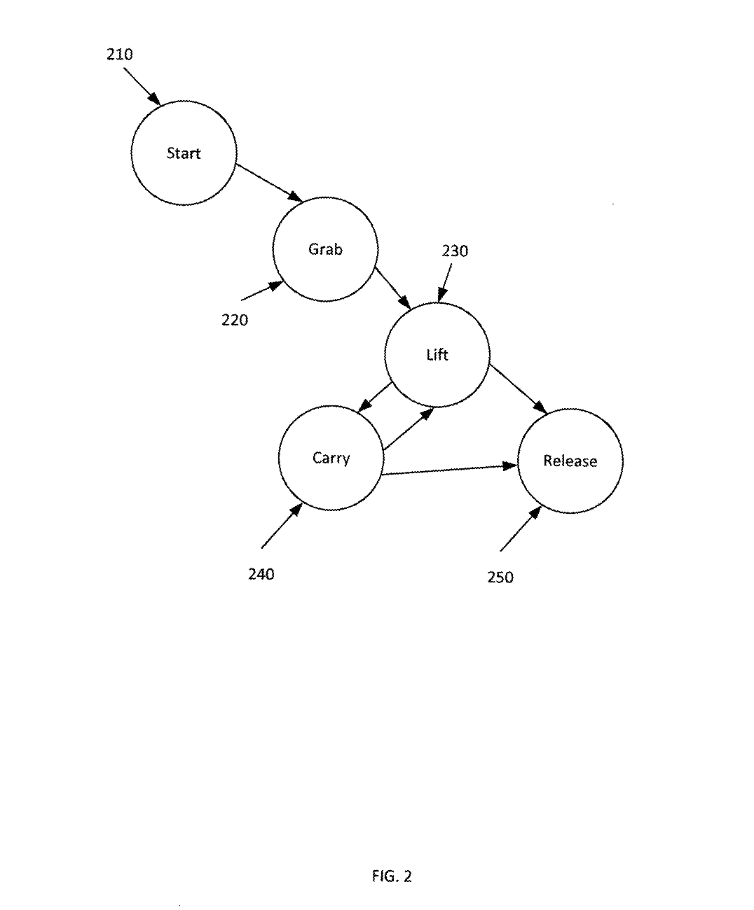

FIG. 2 illustrates an example state diagram associated with an example crane gesture. The state diagram describes states that may be experienced when a crane gesture is performed at a user interface on an apparatus having a display that is both touch-sensitive and hover-sensitive. In one embodiment, the crane gesture may be performed using just hover events.

FIG. 2 illustrates changing the state of the user interface or the crane gesture to a crane-start state 210. In one embodiment, the state is changed upon detecting two touch points on the user interface. In another embodiment the state is changed upon detecting two hover points above the user interface. The state change depends on the two touch points or the two hover points being located at least a crane-start minimum distance apart. The crane-start minimum distance may be, for example, one pixel, ten pixels, ten percent of the pixel width of the display, one centimeter, or other measures. In one embodiment, the crane-start minimum distance may be based, at least in part, on the size of an object displayed on the display. The touch or hover points need to be spaced far enough apart to allow a pinch gesture to identify an object to be grabbed. The state change also depends on the two touch or hover points being located at most a crane-start maximum distance apart. The crane-start maximum distance may be configured to restrict a user to starting the crane gesture in certain regions of a display, on a certain percentage of the display, or in other ways. If the touch or hover points are located too far apart, then it may be difficult, if even possible at all, to perform the gesture with one hand or to identify the object to be pinched and lifted. The state change also depends on an object being displayed at least partially between the two touch points on the display. Recall that the crane gesture is designed to allow a virtual grab, carry, and release action. Therefore, starting a crane gesture sequence, and entering state 210, may depend on identifying an object between two touch or hover points that may be the object of a pinch and grab action.

The state may change from the crane-start state 210 to a crane-grab state 220 upon detecting that the two touch or hover points have moved together to within a crane-grab tolerance distance within a crane-grab tolerance period of time. In one embodiment, the crane-grab tolerance distance may be measured between the two touch or hover points. In one embodiment, the crane-grab tolerance distance may be measured between the object and the touch or hover points. Since an object is the target of the crane gesture, the crane-grab tolerance distance depends, at least in part, on the size of the object. The crane-grab tolerance distance may be, for example, having each of the points come to within one pixel of the object, having each of the points come to within ten pixels of the object, having each of the points move at least 90 percent of the distance from their starting points towards the object, having each of the points move to within one centimeter of the object, or other measures. In one embodiment, the state may change upon determining that the touch or hover points have touched the object. In one embodiment, the touch or hover points may be permitted to cross into the object. In another embodiment, the touch or hover points may not be allowed to cross into the object, but may be restricted to being positioned outside or in contact with the outer edge of the object.

The state may change from the crane-grab state 220 to a crane-lift state 230 upon detecting that the two touch or hover points have retreated from the surface of the display while remaining in a hover zone associated with the display. When the two points are touch points, then retreating the two touch points from the surface of the display may transition the two touch points to hover points. When the two points are hover points, then retreating the two hover points may produce hover point retreat events that note the change in a z distance of the points from the display.

The state may change from the crane-lift state 230 to a crane-carry state 240 upon detecting that at least one of the two hover points has been re-positioned more than a movement threshold amount while remaining within the crane-grab tolerance distance. The movement threshold may be configured to accommodate a random or unintentional small displacement of the object while being lifted or held in the crane-lift state 230. The movement threshold may depend, for example, on the pixel size of the display, on a user-configurable value, or on other parameters. The movement threshold amount may be, for example, one pixel, ten pixels, a percentage of the display size, one centimeter, or other measures. The state may change back from the crane-carry state 240 to the crane-lift state 230 when the object stops moving. In one embodiment, the crane-lift state 230 and the crane-carry state 240 may be implemented in a single state.

The state may change from the crane-lift state 230 or the crane-carry state 240 to a crane-release state 250 upon detecting that the two hover points have moved apart by more than a crane-release threshold distance. The two hover points may be moved apart using, for example, a spread gesture. In one embodiment, the crane-release threshold distance may be satisfied even though just one of the two hover points has moved. The crane-release threshold distance may be, for example, one pixel, ten pixels, one centimeter, a number of pixels that depends on the total size of the display, a number of pixels that depends on the size of the objects, a user-configurable value, or on other measures.

Changing the state from a first state to a second state may include changing a value in a memory on the device associated with the display. Changing the state from a first state to a second state may also include changing an appearance of the user interface. For example, the position of the object may be changed or the appearance of the object may be changed. Therefore, a concrete, tangible, real-world result is achieved on each state transition.

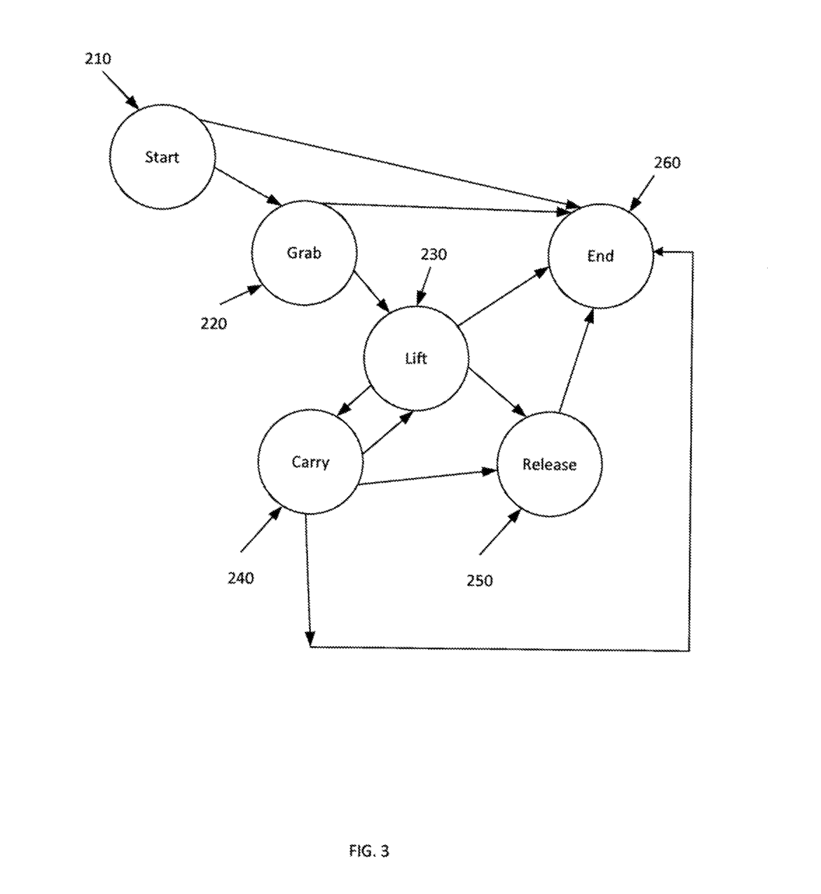

FIG. 3 illustrates another example state diagram associated with an example crane gesture. FIG. 3 includes the states described in FIG. 2 and includes an end state 260. In one embodiment, the end state 260 may be reached from any of the other states. Transitioning from one state to the end state 260 may occur when an end condition is detected. The end condition may be, for example, losing one of the touch points, losing one of the hover points, moving the object off the edge of the display, moving the object out of the hover zone, not taking a qualifying action in a threshold amount of time, or other actions. Transitioning from the release state 250 to the end state 260 may occur upon detecting that a spread gesture has completed and that updates to the display have completed.

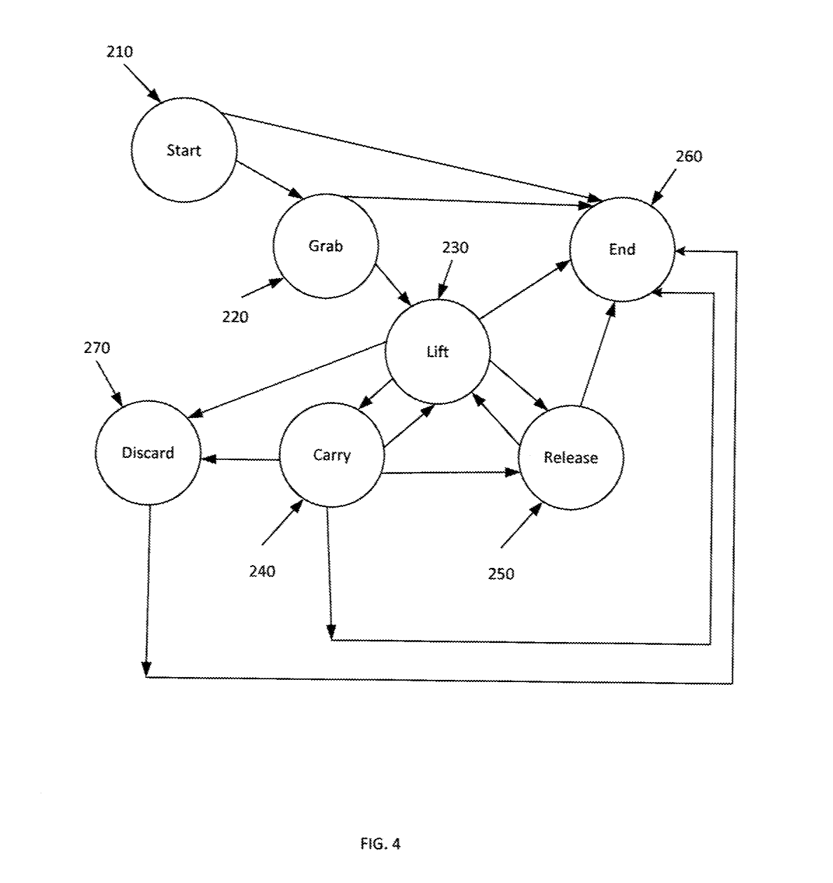

FIG. 4 illustrates another example state diagram associated with an example crane gesture. FIG. 4 includes the states described in FIG. 3 and includes a discard state 270. The discard state 270 may be associated with, for example, a delete function. Rather than dragging an object to a trash can that is displayed on the screen, in one embodiment, the crane gesture may allow the object to be discarded by lifting the object up out of the hover zone. In another embodiment, the crane gesture may allow the object to be discarded by carrying the object off the edge of the display. In one embodiment, the discard state may involve lifting the object out of the hover zone, bringing the object back into the hover zone, and then lifting the object out of the hover zone again as confirmation that discarding the object is desired. Similarly, in one embodiment the discard state may involve carrying the object off the edge of the display, having the object re-enter the hover zone and then carrying the object off the edge of the display again. Other confirmations may be employed for the discard gesture. Being able to discard an item without having to display a trash can on the display saves space on the display and reduces the number of actions required to delete an object.

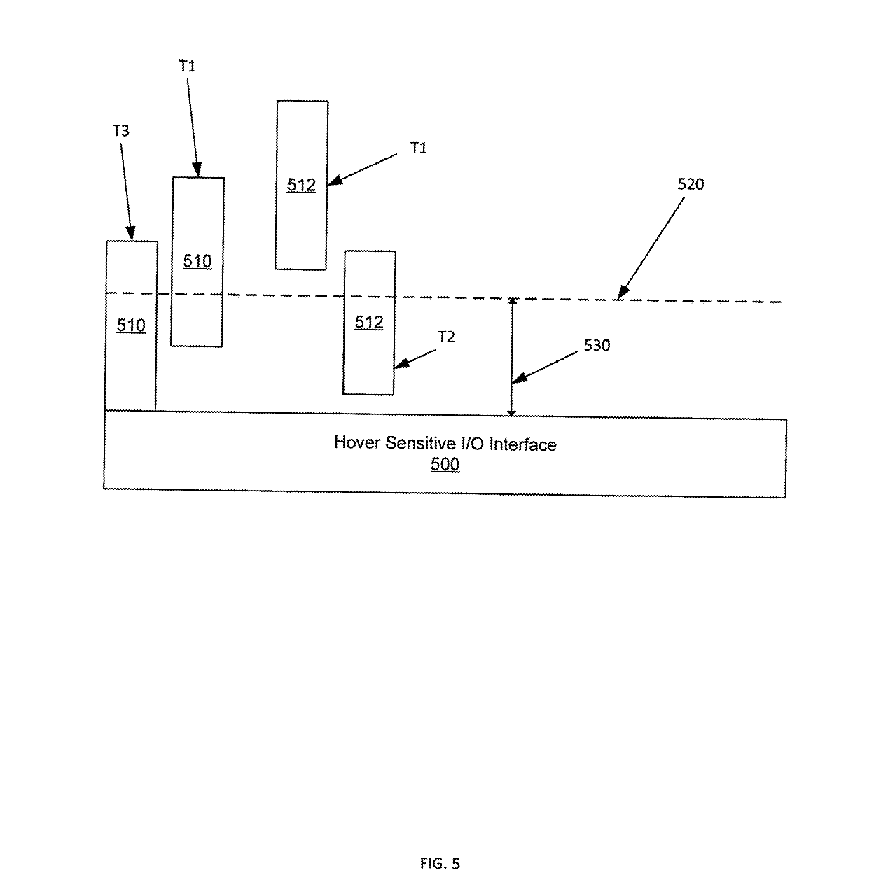

FIG. 5 illustrates a hover-sensitive i/o interface 500. Line 520 represents the outer limit of the hover-space associated with hover-sensitive i/o interface 500. Line 520 is positioned at a distance 530 from i/o interface 500. Distance 530 and thus line 520 may have different dimensions and positions for different apparatus depending, for example, on the proximity detection technology used by a device that supports i/o interface 500.

Example apparatus and methods may identify objects located in the hover-space bounded by i/o interface 500 and line 520. Example apparatus and methods may also identify gestures performed in the hover-space. Example apparatus and methods may also identify items that touch i/o interface 500 and the gestures performed by items that touch i/o interface 500. For example, at a first time T1, an object 510 may be detectable in the hover-space and an object 512 may not be detectable in the hover-space. At a second time T2, object 512 may have entered the hover-space and may actually come closer to the i/o interface 500 than object 510. At a third time T3, object 510 may come in contact with i/o interface 500. When an object enters or exits the hover space an event may be generated. When an object moves in the hover space an event may be generated. When an object touches the i/o interface 500 an event may be generated. When an object transitions from touching the i/o interface 500 to not touching the i/o interface 500 but remaining in the hover space an event may be generated. Example apparatus and methods may interact with events at this granular level (e.g., hover enter, hover exit, hover move, hover to touch transition, touch to hover transition) or may interact with events at a higher granularity (e.g., touch pinch, touch pinch to hover pinch transition, touch spread, hover pinch, hover spread). Generating an event may include, for example, making a function call, producing an interrupt, updating a value in a computer memory, updating a value in a register, sending a message to a service, sending a signal, or other action that identifies that an action has occurred. Generating an event may also include providing descriptive data about the event. For example, a location where the event occurred, a title of the event, and an object involved in the object may be identified.

In computing, an event is an action or occurrence detected by a program that may be handled by the program. Typically, events are handled synchronously with the program flow. When handled synchronously, the program may have a dedicated place where events are handled. Events may be handled in, for example, an event loop. Typical sources of events include users pressing keys, touching an interface, performing a gesture, or taking another user interface action. Another source of events is a hardware device such as a timer. A program may trigger its own custom set of events. A computer program that changes its behavior in response to events is said to be event-driven.

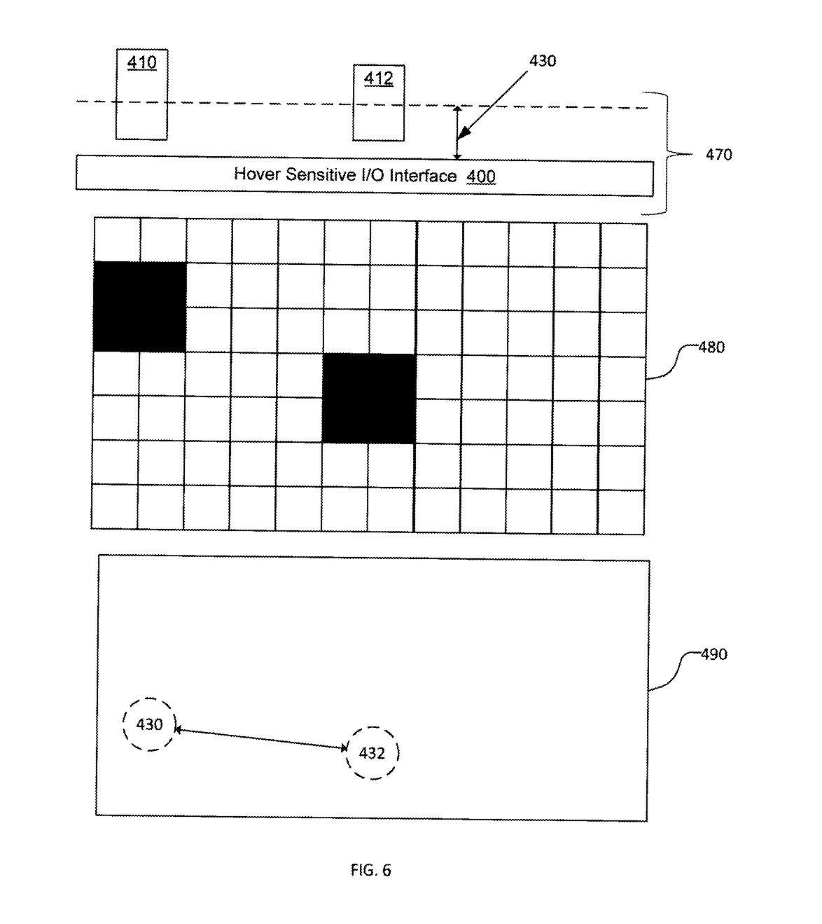

FIG. 6 illustrates actions, objects, and data associated with a crane-start event or state associated with a crane gesture. Region 470 provides a side view of an object 410 and an object 412 that are within the boundaries of a hover space defined by a distance 430 above a hover-sensitive i/o interface 400. Region 480 illustrates a top view of representations of regions of the i/o sensitive interface 400 that are affected by object 410 and object 412. The solid shading of certain portions of region 480 indicates that a hover point is associated with the solid area. Region 490 illustrates a top view representation of a display that may appear on a graphical user interface associated with hover-sensitive i/o interface 400. Dashed circle 430 represents a hover point graphic that may be displayed in response to the presence of object 410 in the hover space and dashed circle 432 represents a hover point graphic that may be displayed in response to the presence of object 412 in the hover space. While two hover points have been detected, a user interface state or gesture state may not transition to the crane-start state because there is no object located between the two hover points. In one embodiment, the dashed circles may be displayed while in another embodiment the dashed circles may not be displayed.

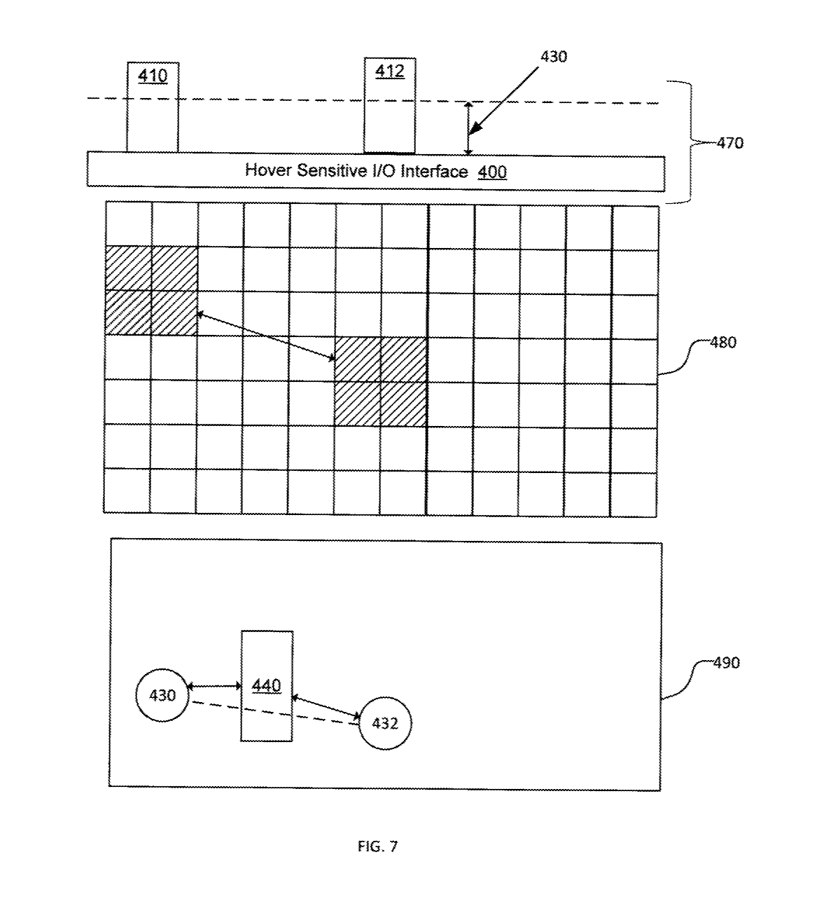

FIG. 7 illustrates actions, objects, and data associated with a crane-start event or state associated with the crane gesture. Object 410 and object 412 have both come in contact with i/o interface 400. Region 480 now illustrates two hatched areas that correspond to two touch points associated with object 410 and 412. Region 490 now illustrates circle 430 and circle 432 as being closed circles, which may be a graphic associated with a touch point. In one embodiment, circle 430 and circle 432 may be displayed while in another embodiment circle 430 and circle 432 may not be displayed.

Region 490 also illustrates an object 440. Object 440 may be a graphic, icon, or other representation of an item displayed by i/o interface 400. Since object 440 has been bracketed by the touch points produced by object 410 and object 412, a dashed line connecting circle 430 and circle 432 may be displayed to indicate that object 440 is a target for a crane gesture. The appearance of object 440 may be manipulated to indicate that object 440 is the target of a crane gesture. If the distance between the touch point associated with circle 430 and the object 440 and the distance between the touch point associated with circle 432 and the object 440 are within crane gesture thresholds, then the user interface or gesture state may be changed to crane-start. If the distance between the touch point associated with circle 430 and the touch point associated with circle 432 are within crane gesture thresholds, then the user interface or gesture state may be changed to crane-start.

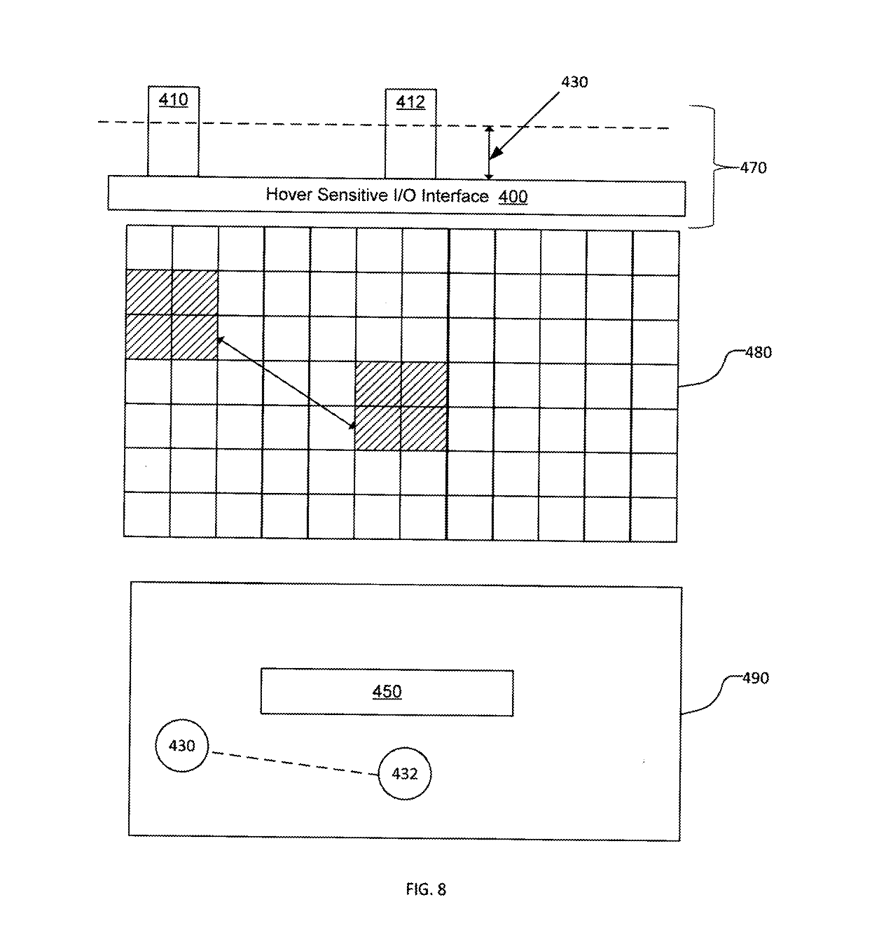

FIG. 8 illustrates a situation where the user interface or gesture state may not be changed to crane-start because object 450 is not bracketed by the touch point associated with circle 430 and the touch point associated with circle 432. Being “bracketed” refers to at least a part of an object being located on a line that connects at least a portion of regions associated with the two touch points or hover points.

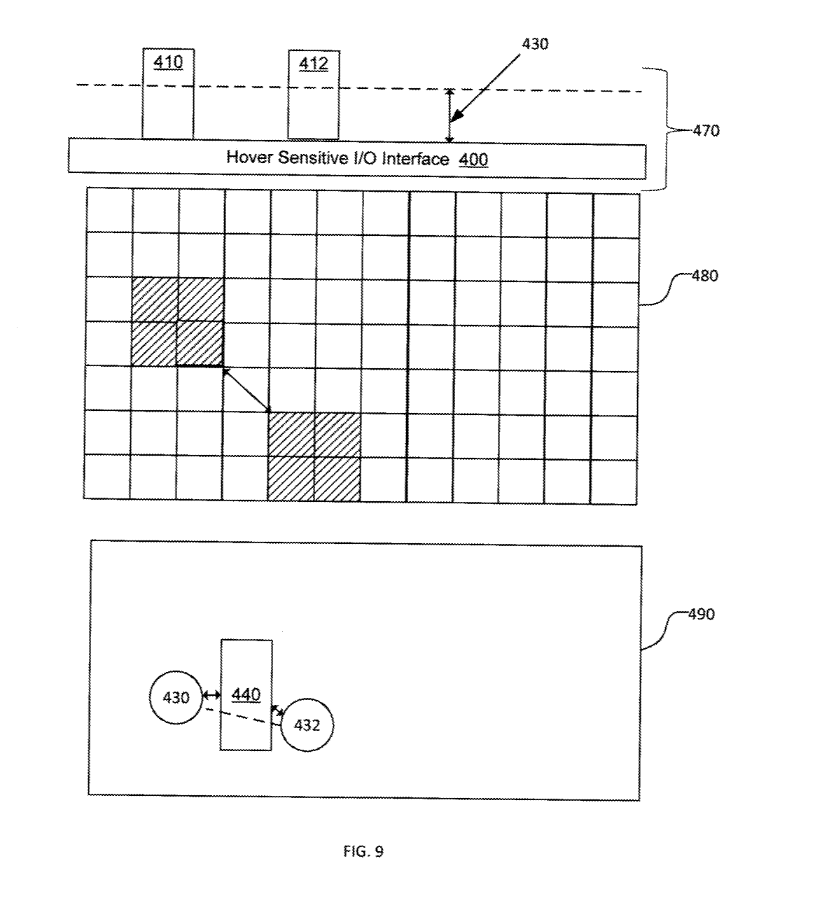

FIG. 9 illustrates actions, objects, and data associated with a crane-grab event or state associated with the crane gesture. Objects 410 and 412 have moved closer together. The touch points associated with objects 410 and 412, which are illustrated by the hatched portions of region 480, have also moved closer together. Region 490 illustrates that circles 430 and 432 have moved closer together and closer to object 440. If objects 410 and 412 have moved close enough together within a short enough period of time, then the user interface or gesture state may transition to a crane-grab state. If objects 410 and 412 have produced touch points that are close enough to object 440, then the user interface or gesture state may transition to the crane-grab state. If the user waits too long to move objects 410 and 412 together, or if the objects are not positioned appropriately, then the transition may not occur. Instead, the user interface state or gesture state may transition to crane-end.

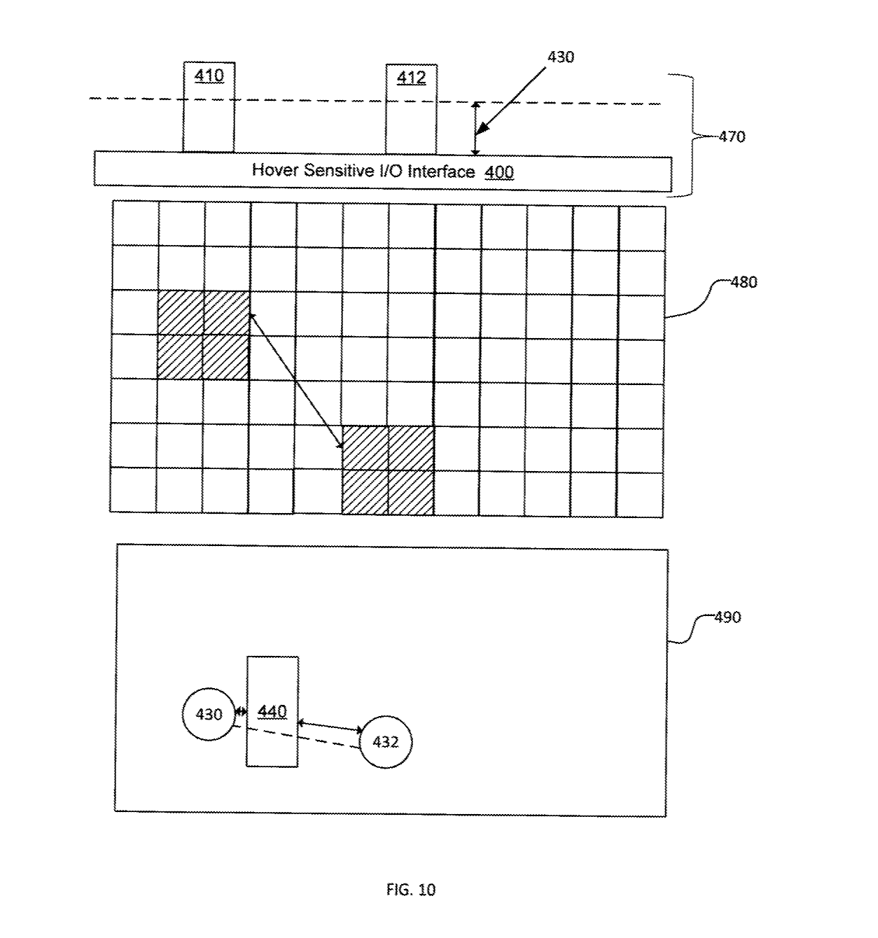

FIG. 10 illustrates the touch point 430 associated with object 410 having moved close enough to object 440 to satisfy a state change condition. However, the touch point 432 associated with object 412 has not moved close enough to object 440. Therefore, the transition to crane-grab may not occur. Instead, if the appropriate relationships between regions associated with objects 410 and 412 and with object 440 do not occur within a threshold period of time, then the user interface state or gesture state may transition to a crane-end state.

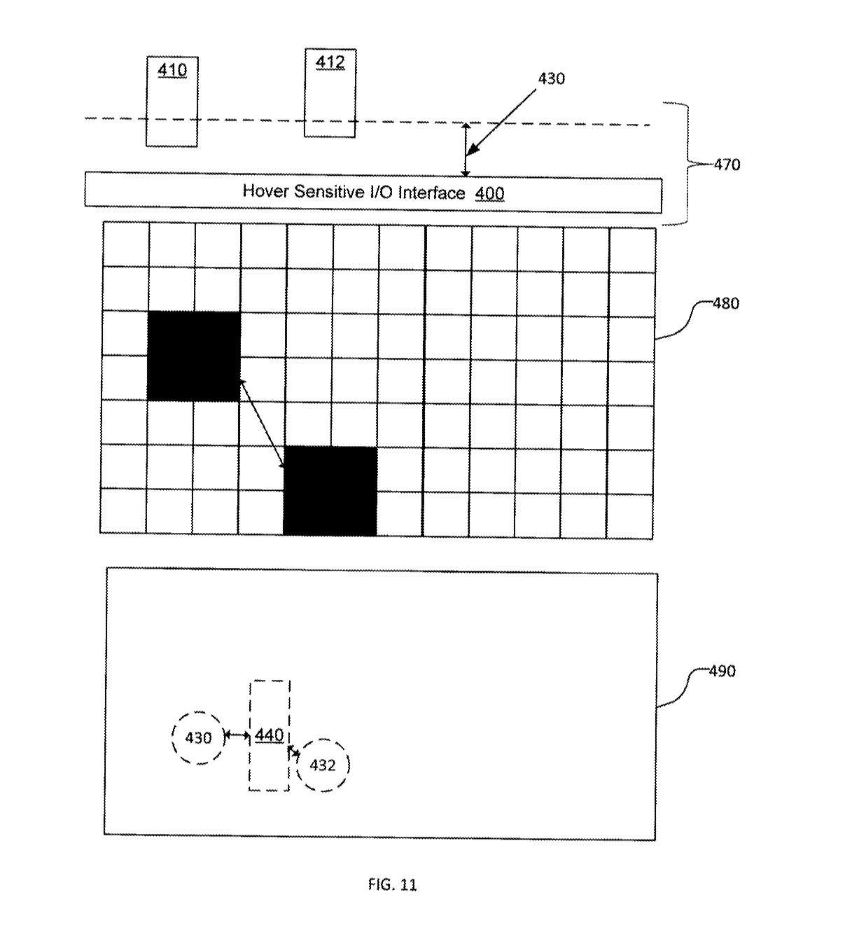

FIG. 11 illustrates actions, objects, and data associated with a crane-lift event or state associated with the crane gesture. Objects 410 and 412 have retreated from hover-sensitive i/o interface 400. The retreats of the objects may have produced touch to hover transitions, therefore region 480 once again shows solid regions that represent the hover points associated with objects 410 and 412 and region 490 once again shows dashed circles 430 and 432 that represent the hover points. Region 490 also illustrates object 440 with a dashed line to indicate that object 440 has been “lifted” off the surface of hover-sensitive i/o interface 400. While dashed lines are used, different embodiments may employ other visual effects to represent that hover points or the lifted object 440. In one embodiment, a shadow effect may be employed. In another embodiment, no effect may be employed.

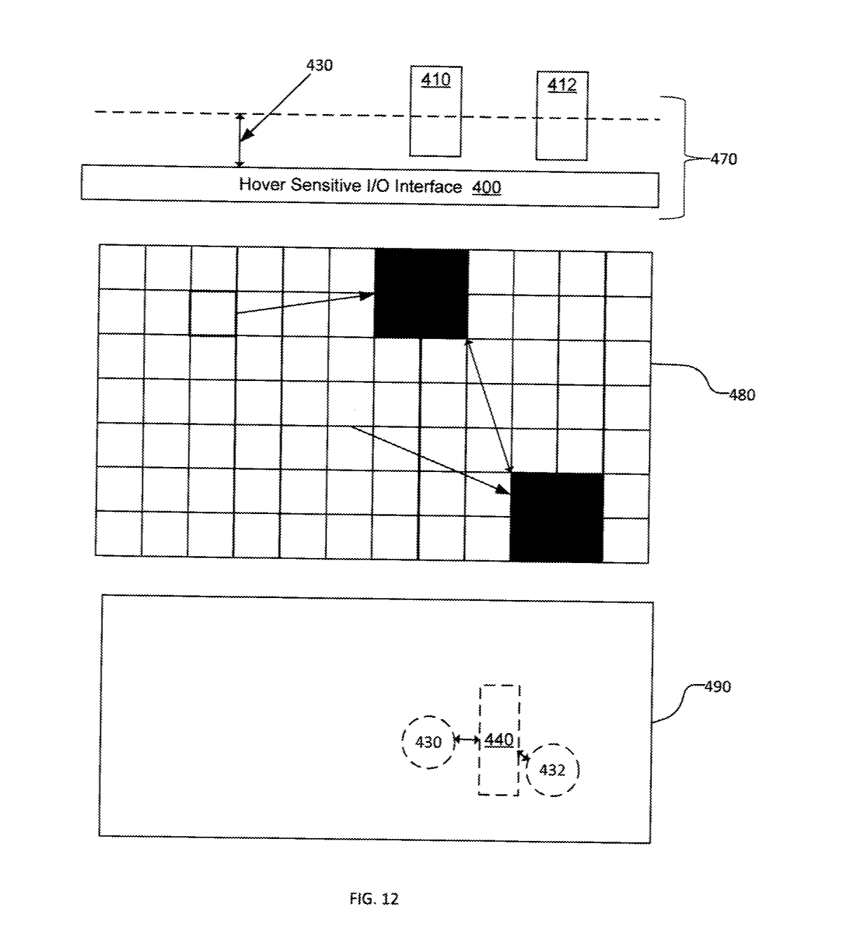

FIG. 12 illustrates actions, objects, and data associated with a crane-carry event or state associated with the crane gesture. Objects 410 and 412 have been moved from the left side of region 470 to the right side of region 470. The solid portions of region 480 have followed objects 410 and 412. The dashed circles 430 and 432 and the dashed object 440 have also followed objects 410 and 412. In one embodiment, the movement of objects 410 and 412 may have produced one or more hover point move events. In one embodiment, the coupled movement of objects 410 and 412 may have produced a crane-carry event. The crane-carry event may be described by data including, for example, a start location, a displacement amount and a displacement direction, an end location, or other information.

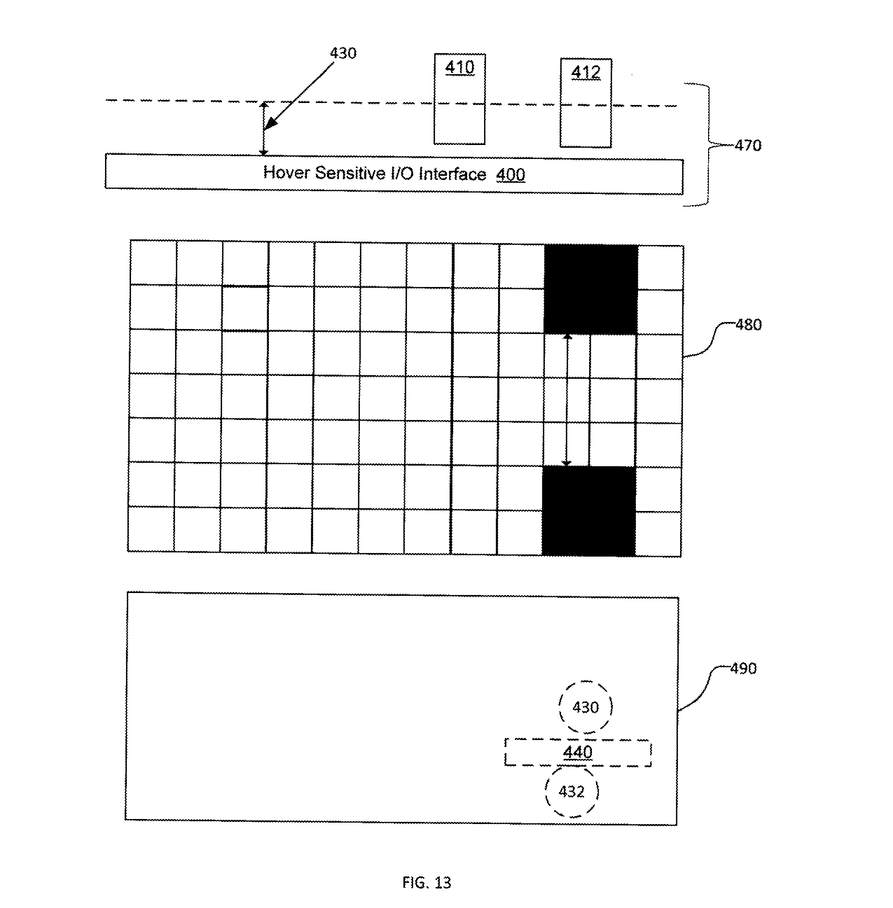

FIG. 13 illustrates actions, objects, and data associated with a crane-carry event or state where the object 440 has been rotated. In FIG. 12, object 440 was substantially vertical while in FIG. 13 object 440 is substantially horizontal. In one embodiment, an object may be displaced and re-oriented during a crane-carry event.

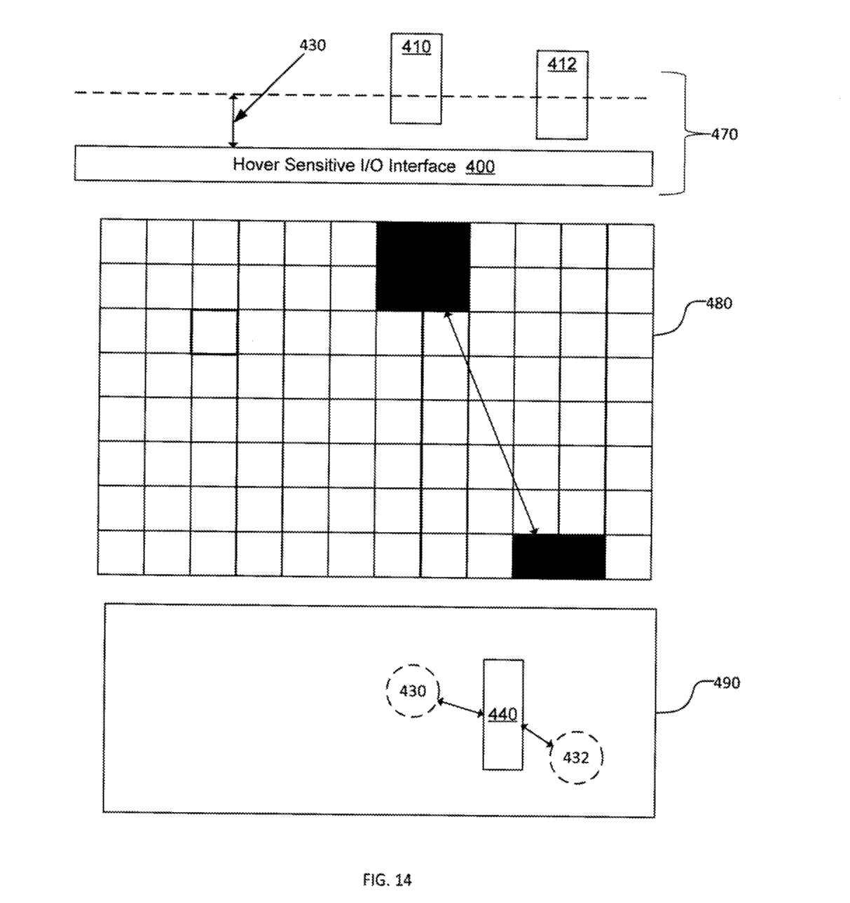

FIG. 14 illustrates actions, objects, and data associated with a crane-release event or state associated with the crane gesture. Objects 410 and 412 have moved apart, which allows object 440 to be released back onto the surface of the display. If objects 410 and 412 move far enough apart in a short enough period of time, then the user interface or gesture state may transition to the crane-release state. In one embodiment, if the object 440 is being displaced when objects 410 and 412 move apart, the object 440 may appear to be thrown in the direction of the displacement. In one embodiment, if the object 440 is being re-oriented (e.g., rotated) when objects 410 and 412 move apart, the object 440 may appear to be spinning. The throw or spin cases facilitate new and interesting gaming interactions, arts and craft interactions, or productivity interactions. For example, in a bowling video game, the throw and spin cases may be used to control the velocity, direction, and rotation of a bowling ball thrown at bowling pins. In another example, in a modern art application, the throw and spin cases may be used to control how virtual paint is cast onto a virtual canvas.

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

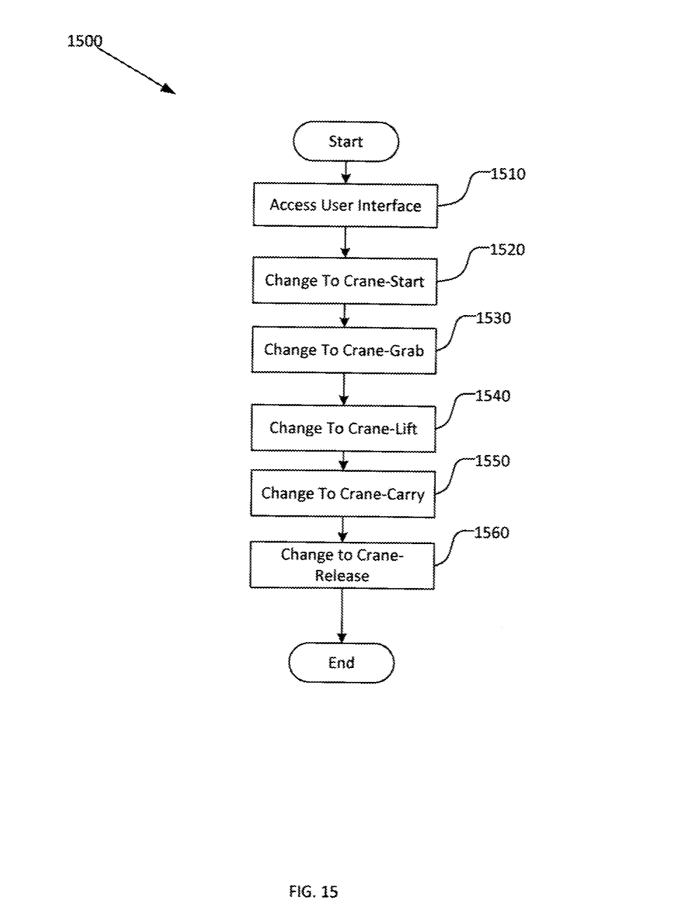

FIG. 15 illustrates an example method 1500 associated with a crane gesture performed with respect to an item displayed on a user interface on an apparatus having an input/output display that is hover-sensitive. Method 1500 may include accessing a user interface for an apparatus having a hover-sensitive input/output display and then selectively controlling the user interface in response to a crane gesture performed using the hover-sensitive input/output display. Thus, method 1500 includes, at 1510, accessing a user interface on the apparatus. Accessing the user interface may include establishing a socket or pipe connection to a user interface process, may include receiving an address where user interface data is stored, may include receiving a pointer to user interface data, may include establishing a remote procedure call interface with a user interface process, may include reading data from memory associated with the user interface, may include receiving data associated with the user interface, or other action.

Method 1500 may also include, at 1520, changing a state associated with the user interface to a crane-start state associated with a crane gesture. The state may be changed upon detecting two bracket points associated with the display. To satisfy a state change condition, the two bracket points may need to be located at least a crane-start minimum distance apart and at most a crane-start maximum distance apart. Additionally, to satisfy the state change condition, an object displayed on the display may need to be located at least partially between the two bracket points. In one embodiment, changing the state from a first state to a second state includes changing a value in a memory or changing an appearance of the user interface. In one embodiment, detecting two bracket points includes receiving two touch point events, receiving two hover point entry events, or receiving two hover point to touch point transition events.

Method 1500 may also include, at 1530, changing the state from the crane-start state to a crane-grab state. The state may be changed upon detecting that the two bracket points have moved together to within a crane-grab tolerance distance within a crane-grab tolerance period of time. Thus, once the bracket points have bracketed an object to be picked up, the next step involves performing a virtual pinch of the object. Thus, in one embodiment, the crane-grab tolerance distance may depend, at least in part, on the size of the object. In one embodiment, detecting that the two bracket points have moved together includes receiving a touch point move event, receiving a touch pinch event, receiving a hover point move event, or receiving a hover pinch event.

Method 1500 may also include, at 1540, changing the state from the crane-grab state to a crane-lift state. The state may be changed upon detecting that the two bracket points have either transitioned from two touch points to two hover points or have moved away from the display more than a threshold distance in the z direction. The crane-lift state corresponds to the previously described physical act of lifting a block up from your desk. The block moves away from the surface of the desk in a z direction that is perpendicular to the desk. Similarly, the virtual object may move away from the display in a z direction that is perpendicular to the display as the objects (e.g., fingers, stylus) that pinched the object move away from the display.

Method 1500 may also include, at 1550, changing the state from the crane-lift state to a crane-carry state. The state may change upon detecting that at least one of the two bracket points has been re-positioned more than a movement threshold amount while remaining within the crane-grab tolerance distance. In one embodiment, detecting that a bracket point has been re-positioned more than a movement threshold amount while remaining within the crane-grab tolerance distance includes receiving a hover point movement event. This corresponds to the previously described repositioning of the block to a different portion of your desk. As the fingers or stylus move above the display, their hover positions are detected and, if the hover positions move far enough, then the virtual item that was lifted off the display can be repositioned based on the new hover positions.

Method 1500 may also include, at 1560, changing the state from the crane-lift state to a crane-release state or changing the state from the crane-carry state to the crane-release state. The state may be changed upon detecting that the two bracket points have moved apart by more than a crane-release threshold distance. In one embodiment, changing the state to the crane-release state causes the object to be displayed at a location determined by the positions of the two bracket points after the two bracket points have moved apart by more than the crane-release threshold distance. In one embodiment, detecting that the two bracket points have moved apart by more than a crane-release threshold distance includes receiving a hover point movement event or a hover point spread event. This corresponds to the person who picked up the block between their thumb and index finger spreading their thumb and index finger to drop the block.

In one embodiment, method 1500 may include changing the state from the crane-carry state to the crane-release state at 1560 upon detecting that the two bracket points have transitioned from two hover points to two touch points. This corresponds to the person who picked up the block putting the block back down on the desk. This change to the crane-release state may not involve detecting a spreading of the hover points or touch points. This change to the crane-release state may also be used to perform a multi-release action where the object is “placed” at multiple locations. This case may be used, for example, in art projects where a virtual rubber stamp has been inked and is being used to place pony patterns at different places on a virtual canvas.

Method 1500 may include controlling an appearance of the object after the state changes to the crane-release state. The appearance may be based, at least in part, on movement of the object in an x-y plane when the crane-release state is detected. For example, if the object is being moved in the x-y plane, then when the object is released it may appear to be thrown onto the display and may slide or bounce across the display at a rate determined by the rate at which the object was moving in the x-y plane when released. The appearance may also be based on x-y rotation of the object when the crane-release state is detected. For example, if the object was being rotated in the x-y plane, then when the object is released it may appear to spin on the display at a rate determined by the rate at which the object was spinning in the x-y plane. The appearance may also be based, at least in part, on movement of the object in a z direction when the crane-release state is detected. For example, if the object is moving quickly toward the display the object may appear to make a deep indentation on the display while if the object is moving slowly toward the display the object may appear to make a shallow indentation on the display. This case may be useful in, for example, video games.

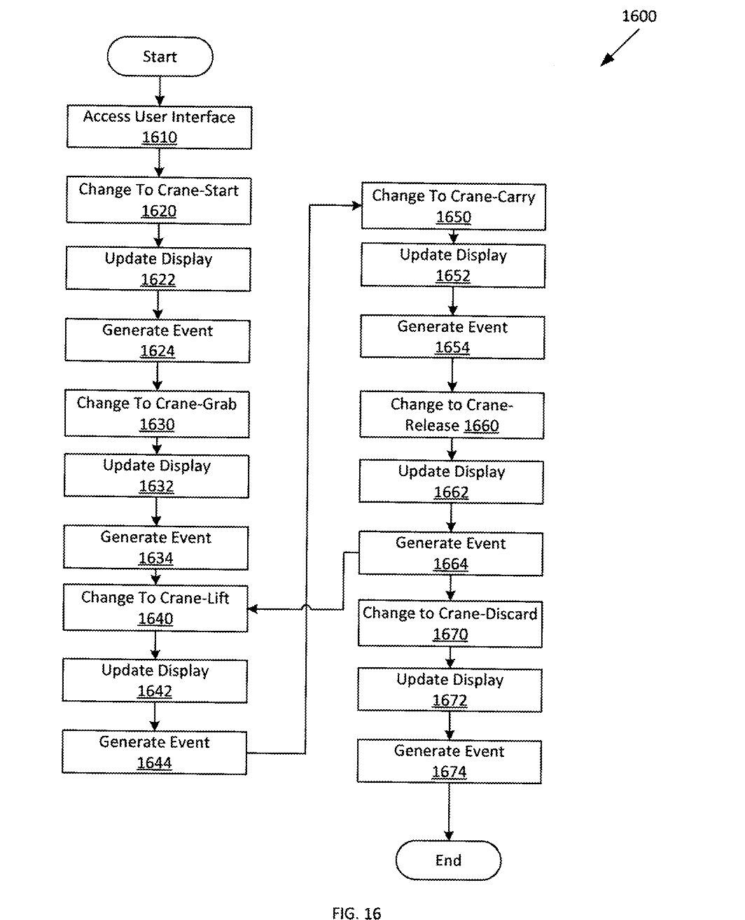

FIG. 16 illustrates an example method 1600 that is similar to method 1500 (FIG. 15). For example, method 1600 includes accessing the user interface at 1610, and changing states at 1620, 1630, 1640, 1650, and 1660. However, method 1600 also includes additional actions.

In one embodiment, method 1600 may include changing the state from the crane-release state back to the crane-lift state upon detecting that the two bracket points have re-grabbed the object within a re-grab threshold period of time. This may facilitate dropping the object at multiple locations using an initial grab gesture followed by repeated release and re-grab gestures. For example, if a virtual salt shaker was picked up, then virtual salt may be sprinkled at various locations on the display by virtually releasing the salt shaker and then virtually re-grabbing the salt shaker. Or, if a virtual water balloon was lifted, then the water balloon may be released at multiple locations on a virtual landscape by releasing the balloon and then performing a grab gesture.

Method 1600 may also include, at 1670, changing the state to a crane-discard state. The state may be changed upon detecting that the two bracket points have exited the hover space for more than a discard threshold period of time. Exiting the hover space may include being lifted up and out of the hover space in the z direction or may include exiting off the edge of the hover space in the x-y plane.

In one embodiment, upon detecting that the state has changed to the crane-discard state, method 1600 may include, at 1672 updating the display to indicate that the item crane-discard state has been achieved. Updating the display may include, for example, removing the lifted item from the display, changing the appearance of the object to indicate that the object has been discarded, or generating a crane discard sound. Method 1600 may also include, at 1674, generating a crane-discard event. The crane-discard event may cause a signal to be sent to a device or process that is participating in managing the display. The crane-discard event may include information about the object discarded, the way in which the object was discarded, the location of the touch or hover points that discarded the object, or other information.

In one embodiment, upon detecting that the state has changed to the crane-start state, method 1600 may include, at 1622 updating the display to indicate that the crane-start state has been achieved. Updating the display may include, for example, displaying a connecting line between the two bracket points, changing the appearance of the object to indicate that the object is a potential target for the crane gesture, or generating a crane gesture sound. Method 1600 may also include, at 1624, generating a crane-start event. The crane-start event may cause a signal to be sent to a device or process that is participating in the crane gesture. The crane-start event may include information about the crane-start including, for example, the location of the object that was bracketed and the location of the touch or hover points that bracketed the object.

In one embodiment, upon detecting that the state has changed to the crane-grab state, method 1600 may include, at 1632, updating the display to indicate that the crane-grab state has been achieved. Updating the display may include changing the appearance of the object to indicate that the object is an actual target for the crane gesture or generating an object grabbed sound. Method 1600 may also include, at 1634, generating a crab-grab event.

In one embodiment, upon detecting that the state has changed to the crane-lift state, method 1600 may include, at 1642, updating the display to indicate that the crane-lift state has been achieved. Updating the display may include, for example, changing the appearance of the object to indicate that the object has been lifted, displaying a shadow of the object on the display, displaying a point at which the object would appear if released from the crane-lift state, or generating an object lifted sound. Method 1600 may also include, at 1644, generating a crane-lift event.

In one embodiment, upon detecting that the state has changed to the crane-carry state, method 1600 may include, at 1652, updating the display to indicate that the crane-carry state has been achieved. Updating the display may include changing the location of the object on the display, changing the position of the shadow on the display, changing the point at which the object would appear if released on the display, or generating an object carry sound. Method 1600 may also include, at 1654, generating a crane-carry event.

In one embodiment, upon detecting that the state has changed to the crane-release state, method 1600 may include, at 1662, updating the display to indicate that the crane-release state has been achieved. Updating the display may include removing the shadow on the display, positioning the object on the display, or generating a crane release sound. Method 1600 may also include, at 1664, generating a crane-release event.

While FIGS. 15 and 16 illustrate various actions occurring in serial, it is to be appreciated that various actions illustrated in FIGS. 15 and 16 could occur substantially in parallel. By way of illustration, a first process could handle events, a second process could generate events, and a third process could manipulate a display. While three processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage medium may store computer executable instructions that if executed by a machine (e.g., computer) cause the machine to perform methods described or claimed herein including methods 1500 or 1600. While executable instructions associated with the listed methods are described as being stored on a computer-readable storage medium, it is to be appreciated that executable instructions associated with other example methods described or claimed herein may also be stored on a computer-readable storage medium. In different embodiments, the example methods described herein may be triggered in different ways. In one embodiment, a method may be triggered manually by a user. In another example, a method may be triggered automatically.

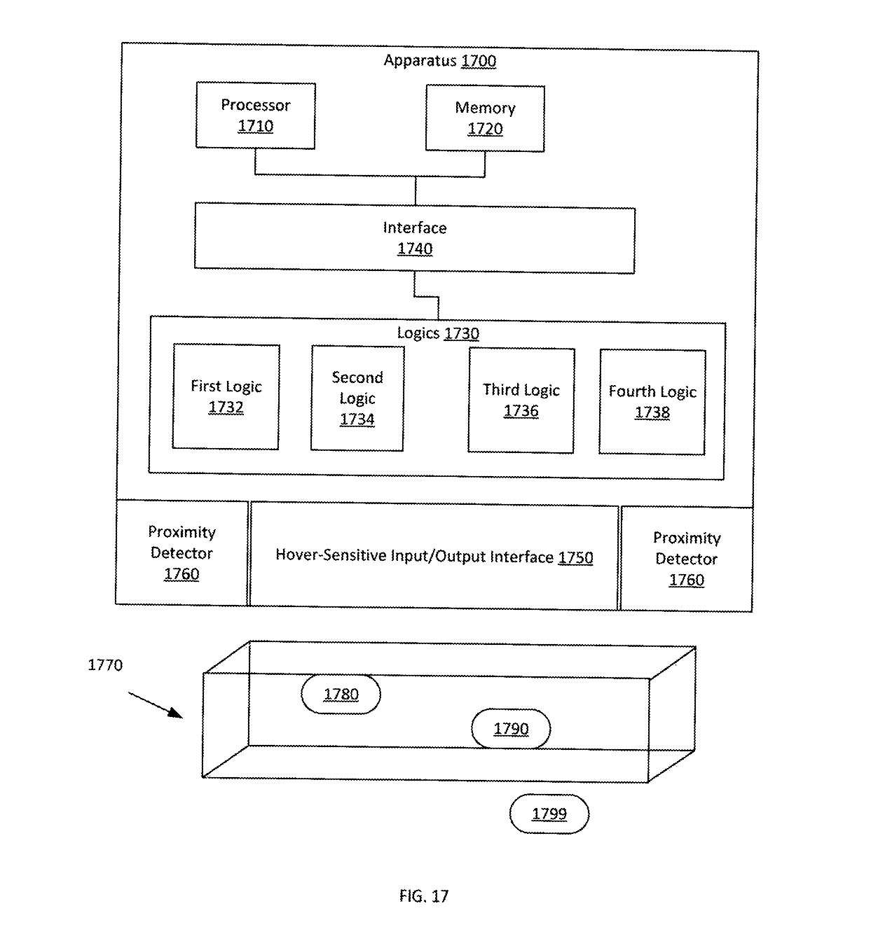

FIG. 17 illustrates an apparatus 1700 that supports crane gesture processing. In one example, the apparatus 1700 includes an interface 1740 configured to connect a processor 1710, a memory 1720, a set of logics 1730, a proximity detector 1760, and a hover-sensitive i/o interface 1750. Elements of the apparatus 1700 may be configured to communicate with each other, but not all connections have been shown for clarity of illustration. The hover-sensitive input/output interface 1750 may be configured to display an item that can be manipulated by a crane gesture. The set of logics 1730 may be configured to manipulate the state of the item in response to the crane gesture.

The proximity detector 1760 may detect an object 1780 in a hover-space 1770 associated with the apparatus 1700. The proximity detector 1760 may also detect another object 1790 in the hover-space 1770. The hover-space 1770 may be, for example, a three dimensional volume disposed in proximity to the i/o interface 1750 and in an area accessible to the proximity detector 1760. The hover-space 1770 has finite bounds. Therefore the proximity detector 1760 may not detect an object 1799 that is positioned outside the hover-space 1770. A user may place a digit in the hover-space 1770, may place multiple digits in the hover-space 1770, may place their hand in the hover-space 1770, may place an object (e.g., stylus) in the hover-space, may make a gesture in the hover-space 1770, may remove a digit from the hover-space 1770, or take other actions. Apparatus 1700 may also detect objects that touch i/o interface 1750. The entry of an object into hover space 1770 may produce a hover-enter event. The exit of an object from hover space 1770 may produce a hover-exit event. The movement of an object in hover space 1770 may produce a hover-point move event. When an object comes in contact with the interface 1750, a hover to touch transition event may be generated. When an object that was in contact with the interface 1750 loses contact with the interface 1750, then a touch to hover transition event may be generated. Example methods and apparatus may interact with these hover and touch events.

Apparatus 1700 may include a first logic 1732 that is configured to change a state associated with the item from untouched to target. The state may be changed in response to detecting the item being bracketed by two bracket points. In one embodiment, the bracket points may be hover points or touch points. In one embodiment, the first logic 1732 may be configured to change the appearance of the item as displayed on the input/output interface 1750 upon determining that the state has changed. The appearance may be changed when the state changes from untouched to target, from target to pinched, from pinched to lifted, or from lifted to released.

Apparatus 1700 may include a second logic 1734 that is configured to change the state from target to pinched. The state may be changed upon detecting that the two bracket points have moved to within a pinch threshold distance of the item.

Apparatus 1700 may include a third logic 1736 that is configured to change the state from pinched to lifted. The state may be changed upon detecting that the bracket points have moved more than a lift threshold distance away from the hover-sensitive input/output interface in the z direction. In one embodiment, the third logic 1736 may be configured to reposition the item on the display in response to detecting that the bracket points have moved more than a movement threshold amount in an x or y direction with respect to the input/output interface 1750.

Apparatus 1700 may also include a fourth logic 1738 that is configured to change the state from lifted to released. The state may be changed upon detecting that the bracket points have moved more than a release threshold distance apart. In one embodiment, the fourth logic 1738 may be configured to change the state from released back to lifted upon detecting that the two bracket points have moved back to within the pinch threshold distance of the item within a re-pinch threshold period of time.

Apparatus 1700 may include a memory 1720. Memory 1720 can include non-removable memory or removable memory. Non-removable memory may include random access memory (RAM), read only memory (ROM), flash memory, a hard disk, or other memory storage technologies. Removable memory may include flash memory, or other memory storage technologies, such as “smart cards.” Memory 1720 may be configured to store user interface state information, characterization data, object data, data about the item, data about the crane gesture, or other data.

Apparatus 1700 may include a processor 1710. Processor 1710 may be, for example, a signal processor, a microprocessor, an application specific integrated circuit (ASIC), or other control and processing logic circuitry for performing tasks including signal coding, data processing, input/output processing, power control, or other functions. Processor 1710 may be configured to interact with logics 1730 that handle a crane gesture.

In one embodiment, the apparatus 1700 may be a general purpose computer that has been transformed into a special purpose computer through the inclusion of the set of logics 1730. The set of logics 1730 may be configured to perform input and output. Apparatus 1700 may interact with other apparatus, processes, and services through, for example, a computer network.

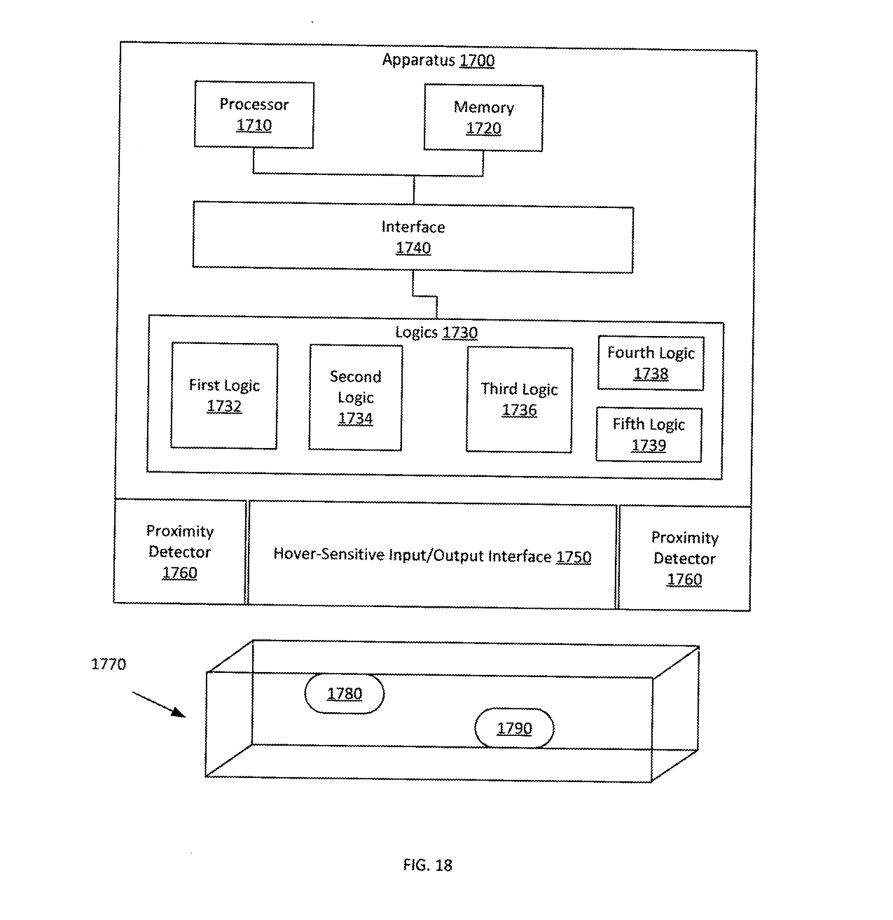

FIG. 18 illustrates another embodiment of apparatus 1700 (FIG. 17). This embodiment of apparatus 1700 includes a fifth logic 1739 that is configured to change the state to discarded upon detecting that the bracket points have left the hover-space. In different embodiments, the bracket points may exit the hover-space to the side (e.g., in x-y plane parallel to display) or may exit the hover-space in the z direction. The discarded state may be used to remove an item from a display or to generate an event that can be handled by a file system (e.g., file delete).

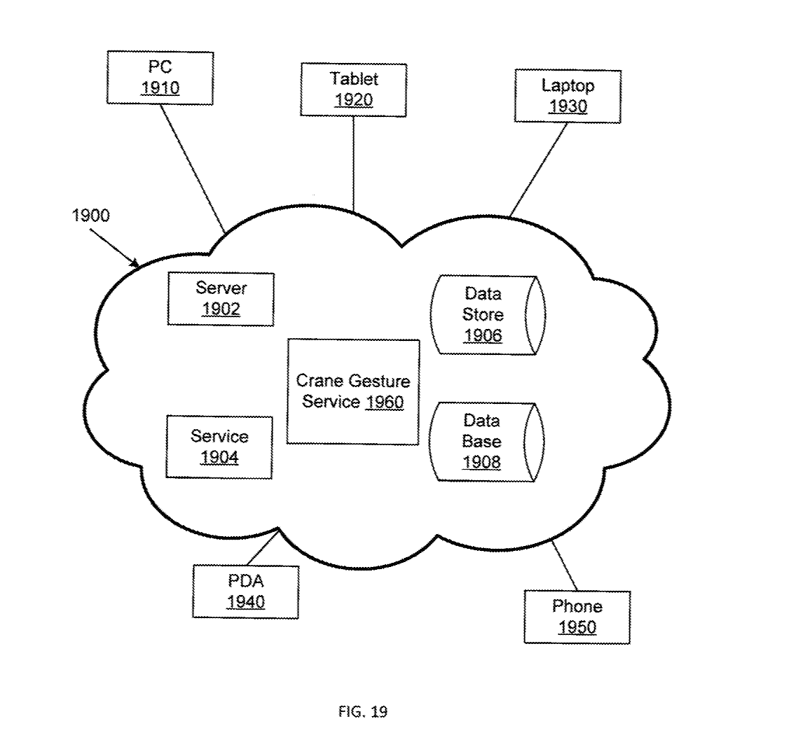

FIG. 19 illustrates an example cloud operating environment 1900. A cloud operating environment 1900 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 19 illustrates an example crane gesture service 1960 residing in the cloud. The crane gesture service 1960 may rely on a server 1902 or service 1904 to perform processing and may rely on a data store 1906 or database 1908 to store data. While a single server 1902, a single service 1904, a single data store 1906, and a single database 1908 are illustrated, multiple instances of servers, services, data stores, and databases may reside in the cloud and may, therefore, be used by the crane gesture service 1960.

FIG. 19 illustrates various devices accessing the crane gesture service 1960 in the cloud. The devices include a computer 1910, a tablet 1920, a laptop computer 1930, a personal digital assistant 1940, and a mobile device (e.g., cellular phone, satellite phone) 1950. It is possible that different users at different locations using different devices may access the crane gesture service 1960 through different networks or interfaces. In one example, the crane gesture service 1960 may be accessed by a mobile device 1950. In another example, portions of crane gesture service 1960 may reside on a mobile device 1950. Crane gesture service 1960 may perform actions including, for example, producing events, handling events, updating a display, recording events and corresponding display updates, or other action. In one embodiment, crane gesture service 1960 may perform portions of methods described herein (e.g., method 1500, method 1800).

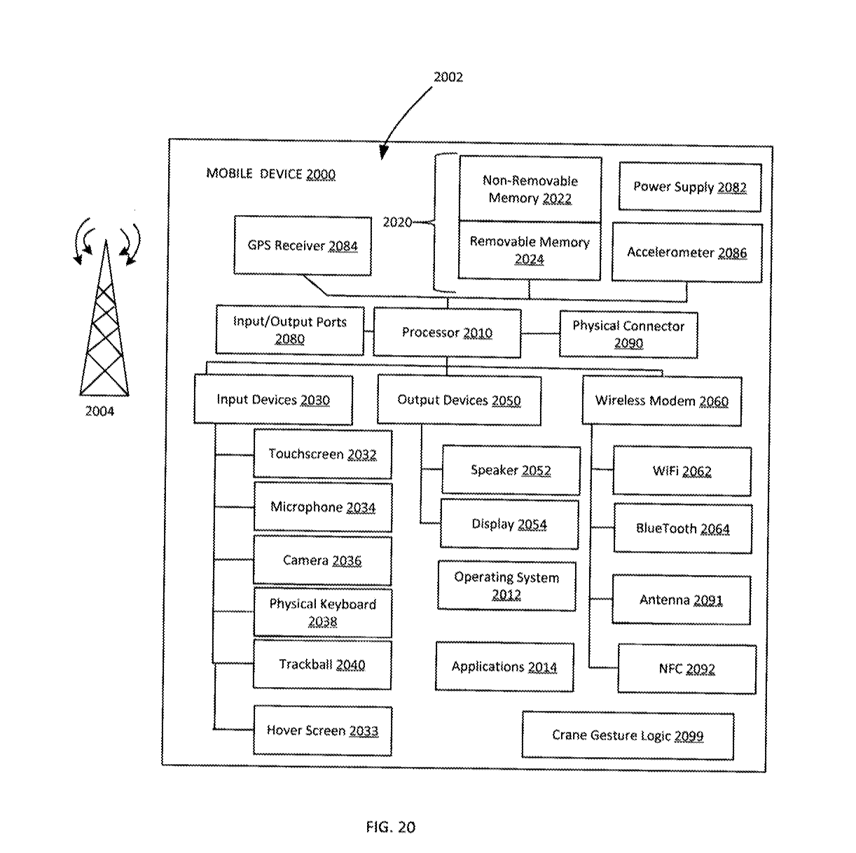

FIG. 20 is a system diagram depicting an exemplary mobile device 2000 that includes a variety of optional hardware and software components, shown generally at 2002. Components 2002 in the mobile device 2000 can communicate with other components, although not all connections are shown for ease of illustration. The mobile device 2000 may be a variety of computing devices (e.g., cell phone, smartphone, handheld computer, Personal Digital Assistant (PDA), etc.) and may allow wireless two-way communications with one or more mobile communications networks 2004, such as a cellular or satellite networks.

Mobile device 2000 can include a controller or processor 2010 (e.g., signal processor, microprocessor, application specific integrated circuit (ASIC), or other control and processing logic circuitry) for performing tasks including signal coding, data processing, input/output processing, power control, or other functions. An operating system 2012 can control the allocation and usage of the components 2002 and support application programs 2014. The application programs 2014 can include mobile computing applications (e.g., email applications, calendars, contact managers, web browsers, messaging applications), gesture handling applications, or other computing applications.

Mobile device 2000 can include memory 2020. Memory 2020 can include non-removable memory 2022 or removable memory 2024. The non-removable memory 2022 can include random access memory (RAM), read only memory (ROM), flash memory, a hard disk, or other memory storage technologies. The removable memory 2024 can include flash memory or a Subscriber Identity Module (SIM) card, which is known in GSM communication systems, or other memory storage technologies, such as “smart cards.” The memory 2020 can be used for storing data or code for running the operating system 2012 and the applications 2014. Example data can include hover point data, touch point data, user interface element state, web pages, text, images, sound files, video data, or other data sets to be sent to or received from one or more network servers or other devices via one or more wired or wireless networks. The memory 2020 can store a subscriber identifier, such as an International Mobile Subscriber Identity (HMSI), and an equipment identifier, such as an International Mobile Equipment Identifier (IMEI). The identifiers can be transmitted to a network server to identify users or equipment.

The mobile device 2000 can support one or more input devices 2030 including, but not limited to, a touchscreen 2032, a hover screen 2033, a microphone 2034, a camera 2036, a physical keyboard 2038, or trackball 2040. While a touch screen 2032 and a physical keyboard 2038 are described, in one embodiment a screen may be both touch and hover-sensitive. The mobile device 2000 may also support output devices 2050 including, but not limited to, a speaker 2052 and a display 2054. Other possible input devices (not shown) include accelerometers (e.g., one dimensional, two dimensional, three dimensional). Other possible output devices (not shown) can include piezoelectric or other haptic output devices. Some devices can serve more than one input/output function. For example, touchscreen 2032 and display 2054 can be combined in a single input/output device.

The input devices 2030 can include a Natural User Interface (NUI). An NUI is an interface technology that enables a user to interact with a device in a “natural” manner, free from artificial constraints imposed by input devices such as mice, keyboards, remote controls, and others. Examples of NUI methods include those relying on speech recognition, touch and stylus recognition, gesture recognition (both on screen and adjacent to the screen), air gestures, head and eye tracking, voice and speech, vision, touch, gestures, and machine intelligence. Other examples of a NUI include motion gesture detection using accelerometers/gyroscopes, facial recognition, three dimensional (3D) displays, head, eye, and gaze tracking, immersive augmented reality and virtual reality systems, all of which provide a more natural interface, as well as technologies for sensing brain activity using electric field sensing electrodes (electro-encephalogram (EEG) and related methods). Thus, in one specific example, the operating system 2012 or applications 2014 can comprise speech-recognition software as part of a voice user interface that allows a user to operate the device 2000 via voice commands. Further, the device 2000 can include input devices and software that allow for user interaction via a user's spatial gestures, such as detecting and interpreting gestures to provide input to an application. In one embodiment, the crane gesture may be recognized and handled by, for example, changing the appearance or location of an item displayed on the device 2000.

A wireless modem 2060 can be coupled to an antenna 2091. In some examples, radio frequency (RF) filters are used and the processor 2010 need not select an antenna configuration for a selected frequency band. The wireless modem 2060 can support two-way communications between the processor 2010 and external devices. The modem 2060 is shown generically and can include a cellular modem for communicating with the mobile communication network 2004 and/or other radio-based modems (e.g., Bluetooth 2064 or Wi-Fi 2062). The wireless modem 2060 may be configured for communication with one or more cellular networks, such as a Global system for mobile communications (GSM) network for data and voice communications within a single cellular network, between cellular networks, or between the mobile device and a public switched telephone network (PSTN). Mobile device 2000 may also communicate locally using, for example, near field communication (NFC) element 2092.

The mobile device 2000 may include at least one input/output port 2080, a power supply 2082, a satellite navigation system receiver 2084, such as a Global Positioning System (GPS) receiver, an accelerometer 2088, or a physical connector 2090, which can be a Universal Serial Bus (USB) port, IEEE 1394 (FireWire) port, RS-232 port, or other port. The illustrated components 2002 are not required or all-inclusive, as other components can be deleted or added.

Mobile device 2000 may include a crane gesture logic 2099 that is configured to provide a functionality for the mobile device 2000. For example, crane gesture logic 2099 may provide a client for interacting with a service (e.g., service 1960, FIG. 19). Portions of the example methods described herein may be performed by crane gesture logic 2099. Similarly, crane gesture logic 2099 may implement portions of apparatus described herein.

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable storage medium”, as used herein, refers to a medium that stores instructions or data. “Computer-readable storage medium” does not refer to propagated signals. A computer-readable storage medium may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage medium may include, but are not limited to, a floppy disk, a flexible disk, a hard disk, a magnetic tape, other magnetic medium, an application specific integrated circuit (ASIC), a compact disk (CD), a random access memory (RAM), a read only memory (ROM), a memory chip or card, a memory stick, and other media from which a computer, a processor or other electronic device can read.

“Data store”, as used herein, refers to a physical or logical entity that can store data. A data store may be, for example, a database, a table, a file, a list, a queue, a heap, a memory, a register, and other physical repository. In different examples, a data store may reside in one logical or physical entity or may be distributed between two or more logical or physical entities.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
accessing a user interface for an apparatus having a hover-sensitive input/output display; and
selectively controlling the user interface in response to a crane gesture performed using the hover-sensitive input/output display.

2. The method of claim 1, where selectively controlling the user interface includes:
changing a state associated with the user interface to a crane-start state associated with the crane gesture upon detecting two bracket points associated with the display, where the two bracket points are located at least a crane-start minimum distance apart, where the two bracket points are located at most a crane-start maximum distance apart, and where an object displayed on the display is located at least partially between the two bracket points;
changing the state from the crane-start state to a crane-grab state upon detecting that the two bracket points have moved together to within a crane-grab tolerance distance within a crane-grab tolerance period of time, where the crane-grab tolerance distance depends, at least in part, on the size of the object;
changing the state from the crane-grab state to a crane-lift state upon detecting that the two bracket points have either transitioned from two touch points to two hover points or have moved away from the display more than a threshold distance in the z direction;
changing the state from the crane-lift state to a crane-carry state upon detecting that at least one of the two bracket points has been re-positioned more than a movement threshold amount while remaining within the crane-grab tolerance distance; and
changing the state from the crane-lift state to a crane-release state or changing the state from the crane-carry state to the crane-release state upon detecting that the two bracket points have moved apart by more than a crane-release threshold distance,
where changing the state from a first state to a second state includes changing a value in a memory or changing an appearance of the user interface, and
where changing the state to the crane-release state causes the object to be displayed at a location determined by the positions of the two bracket points after the two bracket points have moved apart by more than the crane-release threshold distance.

3. The method of claim 2, comprising:
upon detecting that the state has changed to the crane-start state, updating the display to indicate that the crane-start state has been achieved, displaying a connecting line between the two bracket points, changing the appearance of the object to indicate that the object is a potential target for the crane gesture, generating a crane gesture sound, or generating a crane-start event.

4. The method of claim 3, comprising:
upon detecting that the state has changed to the crane-grab state, updating the display to indicate that the crane-grab state has been achieved, changing the appearance of the object to indicate that the object is an actual target for the crane gesture, generating an object grabbed sound, or generating a crane-grab event.

5. The method of claim 4, comprising;
upon detecting that the state has changed to the crane-lift state, updating the display to indicate that the crane-lift state has been achieved, changing the appearance of the object to indicate that the object has been lifted, displaying a shadow of the object on the display, displaying a point at which the object would appear if released from the crane-lift state, generating an object lifted sound, or generating a crane-lift event.

6. The method of claim 5, comprising:
upon detecting that the state has changed to the crane-carry state, updating the display to indicate that the crane-carry state has been achieved, changing the location of the object on the display, changing the position of the shadow on the display, changing the point at which the object would appear if released on the display, generating an object carry sound, or generating a crane-carry event.

7. The method of claim 6, comprising:
upon detecting that the state has changed to the crane-release state, updating the display to indicate that the crane-release state has been achieved, removing the shadow on the display, positioning the object on the display, generating a crane release sound, or generating a crane-release event.

8. The method of claim 1, where detecting two bracket points includes receiving two touch point events, receiving two hover point entry events, or receiving two hover point to touch point transition events, and
where detecting that the two bracket points have moved together includes receiving a touch point move event, receiving a touch pinch event, receiving a hover point move event, or receiving a hover pinch event.

9. The method of claim 1, where detecting that a bracket point has been re-positioned more than a movement threshold amount while remaining within the crane-grab tolerance distance includes receiving a hover point movement event.

10. The method of claim 1, where detecting that the two bracket points have moved apart by more than a crane-release threshold distance includes receiving a hover point movement event or a hover point spread event.

11. The method of claim 1, comprising:
changing the state from the crane-carry state to the crane-release state upon detecting that the two bracket points have transitioned from two hover points to two touch points.

12. The method of claim 1, comprising:
changing the state from the crane-release state back to the crane-lift state upon detecting that the two bracket points have re-grabbed the object within a re-grab threshold period of time.

13. The method of claim 1, comprising:
controlling an appearance of the object after the state changes to the crane-release state, where the appearance is based, at least in part, on movement of the object in an x-y plane when the crane-release state is detected, on x-y rotation of the object when the crane-release state is detected, or on movement of the object in a z direction when the crane-release state is detected.

14. The method of claim 1, comprising:
changing the state to a crane-discard state upon detecting that the two bracket points have exited the hover space for more than a discard threshold period of time.

15. A computer-readable storage medium storing computer-executable instructions that when executed by a computer cause the computer to perform a method, the method comprising:
accessing a user interface on an apparatus having a hover-sensitive input/output display; and
selectively controlling the user interface in response to a crane gesture performed using the hover-sensitive input/output display, where selectively controlling the user interface includes:
changing a state associated with the user interface to a crane-start state associated with the crane gesture upon detecting two bracket points associated with the display, where the two bracket points are located at least a crane-start minimum distance apart, where the two bracket points are located at most a crane-start maximum distance apart, and where an object displayed on the display is located at least partially between the two bracket points, where detecting two bracket points includes receiving two touch point events, receiving two hover point entry events, or receiving two hover point to touch point transition events;
upon detecting that the state has changed to the crane-start state, updating the display to indicate that the crane-start state has been achieved, displaying a connecting line between the two bracket points, changing the appearance of the object to indicate that the object is a potential target for the crane gesture, generating a crane gesture sound, or generating a crane-start event;
changing the state from the crane-start state to a crane-grab state upon detecting that the two bracket points have moved together to within a crane-grab tolerance distance within a crane-grab tolerance period of time, where the crane-grab tolerance distance depends, at least in part, on the size of the object, where detecting that the two bracket points have moved together includes receiving a touch point move event, receiving a touch pinch event, receiving a hover point move event, or receiving a hover pinch event;
upon detecting that the state has changed to the crane-grab state, updating the display to indicate that the crane-grab state has been achieved, changing the appearance of the object to indicate that the object is an actual target for the crane gesture, generating an object grabbed sound, or generating a crab-grab event;
changing the state from the crane-grab state to a crane-lift state upon detecting that the two bracket points have either transitioned from two touch points to two hover points or have moved away from the display more than a threshold distance in the z direction;
upon detecting that the state has changed to the crane-lift state, updating the display to indicate that the crane-lift state has been achieved, changing the appearance of the object to indicate that the object has been lifted, displaying a shadow of the object on the display, displaying a point at which the object would appear if released from the crane-lift state, generating an object lifted sound, or generating a crane-lift event;
changing the state from the crane-lift state to a crane-carry state upon detecting that at least one of the two bracket points has been re-positioned more than a movement threshold amount while remaining within the crane-grab tolerance distance, where detecting that a bracket point has been re-positioned more than a movement threshold amount while remaining within the crane-grab tolerance distance includes receiving a hover point movement event;
upon detecting that the state has changed to the crane-carry state, updating the display to indicate that the crane-carry state has been achieved, changing the location of the object on the display, changing the position of the shadow on the display, changing the point at which the object would appear if released on the display, generating an object carry sound, or generating a crane-carry event;
changing the state from the crane-lift state to a crane-release state or changing the state from the crane-carry state to the crane-release state upon detecting that the two bracket points have moved apart by more than a crane-release threshold distance, where detecting that the two bracket points have moved apart by more than a crane-release threshold distance includes receiving a hover point movement event or a hover point spread event;
changing the state from the crane-carry state to the crane-release state upon detecting that the two bracket points have transitioned from two hover points to two touch points;
upon detecting that the state has changed to the crane-release state, updating the display to indicate that the crane-release state has been achieved, removing the shadow on the display, positioning the object on the display, generating a crane release sound, or generating a crane-release event;
controlling a location of the object after the state changes to the crane-release state, where the location is determined, at least in part, by the positions of the two bracket points after the two bracket points have moved apart by more than the crane-release threshold distance;
controlling an appearance of the object after the state changes to the crane-release state, where the appearance is based, at least in part, on movement of the object in an x-y plane when the crane-release state is detected, on x-y rotation of the object when the crane-release state is detected, or on movement of the object in a z direction when the crane-release state is detected;
changing the state to a crane-discard state upon detecting that the two bracket points have exited the hover space for more than a discard threshold period of time;
changing the state from the crane-release state back to the crane-lift state upon detecting that the two bracket points have re-grabbed the object within a re-grab threshold period of time; and
where changing the state from a first state to a second state includes changing a value in a memory or changing an appearance of the user interface.

16. An apparatus, comprising:
a processor;
a hover-sensitive input/output interface configured to display an item that can be manipulated by a crane gesture;
a memory configured to store a state associated with the item;
a proximity detector configured to detect an object in a hover-space associated with the hover-sensitive input/output interface;
a set of logics configured to manipulate the state of the item in response to the crane gesture; and
an interface configured to connect the processor, the hover-sensitive input/output interface, the proximity detector, the memory, and the set of logics;
the set of logics including:
a first logic configured to change a state associated with the item from untouched to target in response to detecting the item being bracketed by two bracket points, where the bracket points are hover points or touch points;
a second logic configured to change the state from target to pinched upon detecting that the two bracket points have moved to within a pinch threshold distance of the item;
a third logic configured to change the state from pinched to lifted upon detecting that the bracket points have moved more than a lift threshold distance away from the hover-sensitive input/output interface in the z direction; and
a fourth logic configured to change the state from lifted to released upon detecting that the bracket points have moved more than a release threshold distance apart,
where the first logic, second logic, third logic, or fourth logic selectively change the appearance of the item as displayed on the input/output interface upon changing the state.

17. The apparatus of claim 16, where the third logic is configured to reposition the item on the display in response to detecting that the bracket points have moved more than a movement threshold amount in an x or y direction with respect to the input/output interface.

18. The apparatus of claim 17, comprising:
a fifth logic configured to change the state to discarded upon detecting that the bracket points have left the hover-space.

19. The apparatus of claim 18, where the fifth logic is configured to remove the item from the input/output interface upon determining that the state has changed to discarded.

20. The apparatus of cam 15, where the fourth logic is configured to change the state from released to lifted upon detecting that the two bracket points have moved back to within the pinch threshold distance of the item within a re-pinch threshold period of time.
